(19) United States
(12) Patent Application Publication
(10) Pub. No.: US 2026/0357717 A1
(43) Pub. Date: Nov. 12, 2026

(54) TURBOMACHINE CASING

(71) Applicant: SAFRAN AIRCRAFT ENGINES, Paris (FR)

(72) Inventors: Emanuele TAVOLO, MOISSY-CRAMAYEL (FR); Cyril VERBRUGGE, MOISSY-CRAMAYEL (FR)

(73) Assignee: SAFRAN AIRCRAFT ENGINES, Paris (FR)

(21) Appl. No.: 19/666,762

(22) Filed: May 4, 2026

(30) Foreign Application Priority Data
May 6, 2025 (FR) FR2504783

(51) Int. Cl. F01D 25/24

(52) U.S. Cl. CPC F01D 25/24; F05D 2230/10

(57) ABSTRACT

The invention relates to a turbomachine casing (1) centered on a longitudinal axis (X), including inner (18i) and outer (18e) shrouds, and structural arms (18b) connecting them together and extending along a radial axis (R), characterized in that each structural arm (18b) has a plane (PMC) passing through the master cross-section (MC) of the structural arm (18b) and, by observation of each structural arm (18b) in a plane defined by the longitudinal axis (X) and the radial axis (R), perpendicular to the plane (PMC) passing through the master cross-section (MC), the casing (18) has an aerodynamic flowpath opening (OV) at the level of each structural arm (18b), in which a calculated trailing edge outer flowpath tangent

$${Γ}_{e 2 , BF}^{′}$$

is defined as

$${Γ}_{e 2 , BF}^{′} = {Γ}_{eRef , BF} - \vert \frac{{R}_{e 2} - {R}_{eRef}}{{x}_{MC} - {x}_{e , BF}} \vert .$$

### FIELD OF THE INVENTION

The present invention concerns the field of casings for aeronautical propulsion systems or turbomachines, in particular intermediate casings located between high-pressure and low-pressure turbines.

More specifically, the invention mainly relates to the casings called “multi-profile” casings including both radial arms with a structural support and integration function, as well as an aerodynamic nozzle function, and splitter vanes that allow the casing to also fulfill an aerodynamic nozzle function.

### STATE OF THE ART

Conventionally, a turbomachine comprises a combustion chamber, at least one compressor, upstream of the combustion chamber, supplying the combustion chamber with compressed air, and at least one turbine downstream of the combustion chamber, driven by the expansion of the combustion gases. The or each turbine drives the or each compressor via at least one transmission shaft arranged along a main axis of the turbomachine. The or each transmission shaft is movably mounted in rotation relative to the stator (or casing) of the turbomachine via bearings including at least one downstream bearing disposed in the vicinity of the turbine(s). Most often, the or each downstream bearing is arranged at the center of a turbine outlet exhaust casing known as Turbine Rear Frame (TRF) which delimits an annular flowpath guiding the exhaust gases from the low-pressure turbine. It should be noted that, throughout the description, the terms “upstream” and “downstream” refer to the direction of circulation of the air stream inside the turbomachine.

Multi-spool turbomachines for example twin-spool turbomachines, comprising successive high-pressure turbine and low-pressure turbine driven by the exhaust gases are known. More specifically, the high-pressure turbine is disposed at the outlet of the combustion chamber, and the low-pressure turbine is disposed downstream of the high-pressure turbine. Most often, an air channel guiding the gases exiting the high-pressure turbine to the inlet of the low-pressure turbine where they encounter a nozzle, called “low-pressure nozzle”, comprising vanes intended to straighten the air at the inlet of the low-pressure turbine, is arranged between these high-pressure and low-pressure turbines. This low-pressure nozzle, whose function is purely aerodynamic, is hollowed out at its center to allow the passage of the low-pressure transmission shaft.

To improve compactness, it has been proposed to eliminate the turbine outlet casing and replace the air channel and the low-pressure nozzle with an intermediate or inter-turbine casing (better known as TVF for “Turbine Vane Frame” or MTF for “Mid Turbine Frame”) which, in addition to fulfilling the same aerodynamic function as the low-pressure nozzle, acting as a stator to deflect the flow coming from the high-pressure turbine, integrates a structural function that allows passing mechanical forces by guiding the rotation of the transmission shafts relative to the mount. In addition, an integration function is generally provided to ensure the passage of ancillaries, in particular ancillaries for the lubrication fluidly connecting the bearings supported by the inter-turbine casing to parts located radially outside the annular flowpath delimited by the casing.

These three structural, aerodynamic and integration functions are thus typically fulfilled by multi-profile casings. The structural and integration functions are fulfilled by a fairing including an inner shroud and an outer shroud, which together delimit the flowpath between the high-pressure turbine and the low-pressure turbine, as well as structural connecting arms (called “thick arms”) that extend radially between the inner shroud and the outer shroud. The aerodynamic function is fulfilled by these structural connecting arms, which guide the flow, and also by the presence of profiled splitter vanes that allow the casing to ensure the function of a nozzle. It should be noted that “single-profile” casings are also possible when only the connecting arms ensure the guiding of the flow.

Such inter-turbine casings are for example known from applications FR 3 036 437 A1, FR 3 064 297 A1 and FR 3 068 383 A1.

Moreover, climate change is a major concern for many legislative and regulatory bodies around the world. Indeed, various restrictions on carbon emissions have been, are being or will be adopted by various states. Particularly, an ambitious standard applies to both new types of airplanes and those currently in circulation, requiring the implementation of technological solutions to make them compliant with the current regulations. Civil aviation has been actively contributing to the fight against climate change for several years now.

Technological research efforts have already led to very significant improvements in the environmental performance of airplanes. The Applicant takes into account the impacting factors in all the design and development phases to obtain aeronautical components and products that are more energy-efficient, more environmentally friendly and whose integration and use in civil aviation have moderate environmental consequences, with the aim of improving the energy efficiency of the airplanes.

Consequently, the Applicant is constantly working to reduce the climate impact through the use of methods and the operation of processes of virtuous development and manufacture that minimize the greenhouse gas emissions to the minimum possible in order to reduce the environmental footprint of the activity.

These sustained research and development works focus on the new generations of airplane engines, the aircraft weight reduction, in particular through the used materials and the lighter onboard equipment, the development of the use of electric technologies to ensure the propulsion and, as essential complements to technological progress, the aviation biofuels.

One of the technological research objectives being to improve the environmental performance of the aircrafts, in all the design and development phases, the relevant factors are taken into account to obtain aeronautical components and products that are more energy-efficient, more environmentally friendly and whose integration and use in civil aviation have moderate environmental consequences, with the aim of improving the energy efficiency of the aircrafts.

In this context, it is essential to pay particular attention to the performance of the inter-turbine casings described earlier, as these contribute to the proper aerodynamic operation and performance of the low-pressure turbine. Indeed, a degraded performance of such an inter-turbine casing directly impacts the overall performance of the low-pressure turbine and, consequently, the engine consumption. Indeed, the low-pressure turbine and the fan are the two modules mainly responsible for the performance of an engine. Thus, improving the efficiency of these two modules allows reducing its consumption and, consequently, the generated pollution.

Thus, there is a need to improve the performance of such an inter-turbine casing by designing a casing with the lowest possible pressure drops, in order to improve in particular the efficiency of the low-pressure turbine.

### SUMMARY OF THE INVENTION

The invention aims to address, at least partially, the needs mentioned above and the drawbacks relating to the embodiments of the prior art.

One of the aims of the present invention is particularly to determine the values of the parameters conditioning the opening of the flowpath section at the level of the master cross-section of an inter-turbine casing in order to reduce the pressure drops and improve the efficiency of the low-pressure turbine.

To this end, the invention is the result of technological research aimed at significantly improving the performance of the airplanes and, in this respect, contributes to reducing the environmental impact of the airplanes.

To this end, the invention relates to a turbomachine casing centered on a longitudinal axis, including an inner shroud and an outer shroud extending coaxially around the longitudinal axis, and structural arms connecting together the inner shroud and the outer shroud, the structural arms extending along a radial axis perpendicular to the longitudinal axis, each structural arm including a leading edge, a trailing edge, an intrados and an extrados, defining together the outer peripheral surface of the structural arm,
wherein the radially inner end of each structural arm is connected to the inner shroud and the radially outer end of each structural arm is connected to the outer shroud, the radially inner end of each structural arm extending between a first inner inflection point of the leading edge of the structural arm located at the junction between the inner shroud and the leading edge of the structural arm and a second inner inflection point of the structural arm located at the junction between the inner shroud and the trailing edge of the structural arm, and the radially outer end of each structural arm extending between a first outer inflection point of the structural arm located at the junction between the outer shroud and the leading edge of the structural arm and a second outer inflection point of the structural arm located at the junction between the outer shroud and the trailing edge of the structural arm, characterized in that each structural arm has a plane, normal to the longitudinal axis, passing through the master cross-section of the structural arm, whose position along the longitudinal axis is determined as follows:
   generating at least one, preferably three, set(s) of cutting points defining together a cross-sectional surface of the structural arm, each set of cutting points being obtained by creating the intersection between the outer peripheral surface of each structural arm and a plurality of cutting planes normal to the longitudinal axis between the leading edge and the trailing edge of the structural arm, the cutting points being each taken radially at a constant flowpath height ratio h/H along the longitudinal axis, H being, in each cutting plane normal to the considered longitudinal axis, the radius difference between the outer shroud and the inner shroud and h being, in each cutting plane normal to the considered longitudinal axis, the radius difference between the height of the cutting point and the radius of the inner shroud, so as to obtain at least one cross-sectional surface with a constant flowpath height ratio, and preferably a first cross-sectional surface with a flowpath height ratio equal to 10%, a second cross-sectional surface with a flowpath height ratio equal to 50%, and a third cross-sectional surface with a flowpath height ratio equal to 90%, each intersection between the outer peripheral surface of each structural arm and one of the cutting planes normal to the longitudinal axis at a flowpath height ratio giving an intrados cutting point located on the intrados side of the structural arm and an extrados cutting point located on the extrados side of the structural arm,
   then, for each cross-sectional surface, inscribing a plurality of cylinders inside the structural arm, each cylinder having a diameter and a generatrix perpendicular to the longitudinal axis and without intersection with the outer peripheral surface of the structural arm, the largest diameter allowing identifying the largest inscribable cylinder which gives, through the axial position of its generatrix, the position along the longitudinal axis of the master cross-section associated with the cross-sectional surface, and preferably at least three positions along the longitudinal axis of the master cross-section each associated with a cross-sectional surface.
   determining the arithmetic mean of the position(s) along the longitudinal axis of the master cross-section to obtain a mean position of the master cross-section along the longitudinal axis defining the master cross-section, the plane passing through the master cross-section being the plane perpendicular to the longitudinal axis and passing through the mean position of the master cross-section at +2%, wherein, by observation of each structural arm in a plane defined by the longitudinal axis and the radial axis, perpendicular to the plane passing through the master cross-section, the casing has an aerodynamic flowpath opening at the level of each structural arm defined:
   by an aerodynamic flowpath inner opening which has an inner radial spacing formed between, on the one hand, the junction between the inner shroud and the radially inner end of the structural arm and, on the other hand, the straight line joining the first inner inflection point and the second inner inflection point, and/or
   by an aerodynamic flowpath outer opening which has an outer radial spacing formed between, on the one hand, the junction between the outer shroud and the radially outer end of the structural arm and, on the other hand, the straight line joining the first outer inflection point and the second outer inflection point, wherein the intersection between the straight line joining the first inner inflection point and the second inner inflection point, and the plane passing through the master cross-section of the structural arm, defines a reference inner radius R_{iRef} along the radial axis,
the intersection between the straight line joining the first outer inflection point and the second outer inflection point, and the plane passing through the master cross-section of the structural arm, defines a reference outer radius R_{eRef} along the radial axis,
the intersection between the junction of the inner shroud with the radially inner end of the structural arm forming the aerodynamic flowpath inner opening, and the plane passing through the master cross-section of the structural arm, defines an inner opening radius Rᵢ₂ along the radial axis,
the intersection between the junction of the outer shroud with the radially outer end of the structural arm forming the aerodynamic flowpath outer opening and the plane passing through the master cross-section of the structural arm, defines an outer opening radius Rₑ₂ along the radial axis; wherein a calculated trailing edge outer flowpath tangent

$${Γ}_{e 2 , BF}^{′}$$

is defined as:

$${Γ}_{e 2 , BF}^{′} = {Γ}_{eRef , BF} - \vert \frac{{R}_{e 2} - {R}_{eRef}}{{x}_{MC} - {x}_{e , BF}} \vert$$

with:

$${Γ}_{eRef , BF} = \frac{{R}_{eRef} - {R}_{e , BF}}{{x}_{MC} - {x}_{e , BF}}$$

where:
Γ_{eRef,BF} is the trailing edge reference outer flowpath tangent, passing through the second outer inflection point of the trailing edge of the structural arm and through the reference outer opening point, located at the reference outer radius R_{eRef} along the radial axis and at the mean position of the master cross-section along the longitudinal axis,
R_{e,BF} is the radius along the radial axis of the second outer inflection point of the trailing edge of the structural arm,
x_{e,BF} is the position along the longitudinal axis of the second outer inflection point of the trailing edge of the structural arm,
and wherein the trailing edge outer flowpath tangent Γ_{e2,BF}, passing through the second outer inflection point of the trailing edge of the structural arm and through the outer opening point, located at the outer opening radius Rₑ₂ and at the mean position of the master cross-section along the longitudinal axis, is chosen such that:

$$0.95 \times {Γ}_{e 2 , BF}^{′} \leq {Γ}_{e 2 , BF} < {Γ}_{eRef , BF}$$

The turbomachine casing may have one or more of the following characteristics.

In one embodiment, a calculated outer opening radius

$${R}_{e 2}^{′}$$

is defined as:

$${R}_{e 2}^{′} = \frac{- {b}_{e} + \sqrt{{Δ}_{e}}}{2 {a}_{e}}$$

with:

$${Δ}_{e} = {b}_{e}^{2} - 4 {a}_{e} {c}_{e}$$

and:

$${b}_{e} = - \frac{MC}{π} {N}_{b}$$

and:

$${c}_{e} = - ( \frac{χ {S}_{o}}{π} - \frac{MC}{π} {N}_{b} {R}_{eRef} + {R}_{eRef}^{2} )$$

and:

Sₒ=MC(R_{eRef}−R_{iRef})N_{b}
where:
MC is the master cross-section of the structural arm,
Nb is the number of structural arms of the casing,
X is a distribution factor of the obstructed section Sₒ,
aₑ is a predefined coefficient,
wherein:
R_{eRef} is chosen such that 0.21 m≤R_{eRef}≤0.30 m, R_{iRef} is chosen such that 0.14 m≤R_{iRef}≤0.23 m,
MC is chosen such that 0.018 m≤MC≤0.035 m,
Nb is chosen such that 8≤Nb≤24,
Sₒ is chosen such that 0.01 m²≤Sₒ≤0.10 m²,
χ is chosen such that 0≤χ≤1,
aₑ is chosen such that aₑ=1.

In one embodiment, the outer opening radius Rₑ₂ is chosen such that

$${R}_{eRef} < {R}_{e 2} \leq {R}_{e 2}^{′} .$$

In one embodiment, the outer opening radius Rₑ₂ is chosen such that:

$${R}_{e 2} = {R}_{e 2}^{′} \times \frac{1}{ε}$$

where:
ε is a resetting factor of the radius Rₑ₂ chosen such that 1≤ε≤1.04.

In one embodiment, the outer opening radius Rₑ₂ is chosen such that:

$$0.99 \times {R}_{e 2}^{′} \times \frac{1}{ε} \leq {R}_{e 2} \leq 1.01 \times {R}_{e 2}^{′} \times \frac{1}{ε}$$

In one embodiment, a calculated inner opening radius

$${R}_{i 2}^{′}$$

is defined as:

$${R}_{i 2}^{′} = \frac{- {b}_{i} + \sqrt{{Δ}_{i}}}{2 {a}_{i}}$$

with:

$${Δ}_{i} = {b}_{i}^{2} - 4 {a}_{i} {c}_{i}$$

and:

$${b}_{i} = - \frac{MC}{π} {N}_{b}$$

and:

$${c}_{i} = \frac{( 1 - χ ) {S}_{o}}{π} + \frac{MC}{π} {N}_{b} {R}_{iRef} - {R}_{iRef}^{2}$$

where:
aᵢ is a predefined coefficient,
wherein:
aᵢ is chosen such that aᵢ=1.

In one embodiment, the inner opening radius Rᵢ₂ is chosen such that

$${R}_{i 2}^{′} \leq {R}_{i 2} < {R}_{iRef} .$$

In one embodiment, the inner opening radius Rᵢ₂ is chosen such that:

$${R}_{i 2} = {R}_{i 2}^{′} \times ε$$

where:

ε is a resetting factor of the radius Rᵢ₂ chosen such that 1≤E≤1.04.

In one embodiment, the inner opening radius Rᵢ₂ is chosen such that:

$$0.99 \times {R}_{i 2}^{′} \times ε \leq {R}_{i 2} \leq 1.01 \times {R}_{i 2}^{′} \times ε$$

In one embodiment, a calculated leading edge inner flowpath tangent

$${Γ}_{i 2 , BA}^{′}$$

is defined as:

$${Γ}_{i 2 , BA}^{′} = {Γ}_{iRef , BA} - \vert \frac{{R}_{i 2} - {R}_{iRef}}{{x}_{MC} - {x}_{i , BA}} \vert$$

with:

$${Γ}_{iRef , BA} = \frac{{R}_{iRef} - {R}_{i , BA}}{{x}_{MC} - {x}_{i , BA}}$$

where:
Γ_{iRef,BA} is the leading edge reference inner flowpath tangent, passing through the first inner inflection point of the leading edge of the structural arm and through the reference inner opening point, located at the reference inner radius R_{iRef} along the radial axis and at the mean position of the master cross-section along the longitudinal axis,
R_{i,BA} is the radius along the radial axis of the first inner inflection point of the leading edge of the structural arm,
X_{i,BA} is the position along the longitudinal axis of the first inner inflection point of the leading edge of the structural arm.

In one embodiment, the leading edge inner flowpath tangent Γ_{i2,BA}, passing through the first inner inflection point of the leading edge of the structural arm and through the inner opening point, located at the inner opening radius Rᵢ₂ and at the mean position of the master cross-section along the longitudinal axis, is chosen such that:

$$0.95 \times {Γ}_{i 2 , BA}^{′} \leq {Γ}_{i 2 , BA} < {Γ}_{iRef , BA}$$

In one embodiment, a calculated leading edge outer flowpath tangent

$${Γ}_{e 2 , BA}^{′}$$

is defined as:

$${Γ}_{e 2 , BA}^{′} = {Γ}_{eRef , BA} + \vert \frac{{R}_{e 2} - {R}_{eRef}}{{x}_{MC} - {x}_{e , BA}} \vert$$

with:

$${Γ}_{eRef , BA} = \frac{{R}_{eRef} - {R}_{e , BA}}{{x}_{MC} - {x}_{e , BA}}$$

where:
Γ_{eRef,BA} is the leading edge reference outer flowpath tangent, passing through the first outer inflection point of the leading edge of the structural arm and through the reference outer opening point, located at the reference outer radius R_{eRef} along the radial axis and at the mean position of the master cross-section along the longitudinal axis,
R_{e,BA} is the radius along the radial axis of the first outer inflection point of the leading edge of the structural arm,
x_{e,BA} is the position along the longitudinal axis of the first outer inflection point of the leading edge of the structural arm.

In one embodiment, the leading edge outer flowpath tangent Γ_{e2,BA}, passing through the first outer inflection point of the leading edge of the structural arm and through the outer opening point, located at the outer opening radius Rₑ₂ and at the mean position of the master cross-section along the longitudinal axis, is chosen such that:

$${Γ}_{eRef , BA} < {Γ}_{e 2 , BA} \leq 1.05 \times {Γ}_{e 2 , BA}^{′}$$

In one embodiment, a calculated trailing edge inner flowpath tangent

$${Γ}_{i 2 , BF}^{′}$$

is defined as:

$${Γ}_{i 2 , BF}^{′} = {Γ}_{iRef , BF} + \vert \frac{{R}_{i 2} - {R}_{iRef}}{{x}_{MC} - {x}_{i , BF}} \vert$$

with:

$${Γ}_{iRef , BF} = \frac{{R}_{iRef} - {R}_{i , BF}}{{x}_{MC} - {x}_{i , BF}}$$

where:
Γ_{iRef,BF} is the trailing edge reference inner flowpath tangent, passing through the second inner inflection point of the trailing edge of the structural arm and through the reference inner opening point, located at the reference inner radius R_{iRef} along the radial axis and at the mean position of the master cross-section along the longitudinal axis,
R_{i,BF} is the radius along the radial axis of the second inner inflection point of the trailing edge of the structural arm,
x_{i,BF} is the position along the longitudinal axis of the second inner inflection point of the trailing edge of the structural arm.

In one embodiment, the trailing edge inner flowpath tangent Γ_{i2,BF}, passing through the second inner inflection point of the trailing edge of the structural arm and through the inner opening point, located at the inner opening radius Rᵢ₂ and at the mean position of the master cross-section along the longitudinal axis, is chosen such that:

$${Γ}_{iRef , BF} < {Γ}_{i 2 , BF} \leq 1.05 \times {Γ}_{i 2 , BF}^{′}$$

In one embodiment, the aerodynamic flowpath opening has, by sectional observation in a plane defined by the tangential axis and the radial axis at the level of the plane passing through the master cross-section of the structural arm, an outer circular ring representing the excess section related to the aerodynamic flowpath opening relative to the section obstructed by the structural arm, the outer circular ring being defined as:

$$Δ {S}_{e} = π ( {R}_{e 2}^{2} - {R}_{eRef}^{2} ) - MC ( {R}_{e 2} - {R}_{eRef} ) {N}_{b} = χ {S}_{o}$$

wherein the parameter ΔSₑ is chosen such that ΔSₑ is strictly greater than 0% and strictly less than 100% of the obstructed section Sₒ.

In one embodiment, the parameter ΔSₑ is chosen such that ΔSₑ is comprised between 40% and 60% of the obstructed section Sₒ.

In one embodiment, the aerodynamic flowpath opening has, by sectional observation in a plane defined by the tangential axis and the radial axis at the level of the plane passing through the master cross-section of the structural arm, an inner circular ring representing the excess section related to the aerodynamic flowpath opening relative to the section obstructed by the structural arm,
the inner circular ring being defined as:

$$Δ {S}_{i} = π ( {R}_{iRef}^{2} - {R}_{i 2}^{2} ) - MC ( {R}_{iRef} - {R}_{i 2} ) {N}_{b} = ( 1 - χ ) {S}_{o}$$

wherein the parameter ΔSᵢ is chosen such that ΔSᵢ is strictly greater than 0% and strictly less than 100% of the obstructed section Sₒ.

In one embodiment, the parameter ΔSᵢ is chosen such that ΔSᵢ is comprised between 40% and 60% of the obstructed section Sₒ.

In one embodiment, the outer shroud includes a plurality of openings, each receiving the tip of a splitter vane and in which a plurality of splitter vanes are arranged circumferentially between two structural arms.

In one embodiment, the casing is an inter-turbine casing intended to be positioned between a low-pressure turbine and a high-pressure turbine.

Moreover, the invention also relates, according to another of its aspects, to a turbomachine including a casing as defined above.

Furthermore, the invention also relates, according to another of its aspects, to a method for dimensioning a turbomachine casing centered on a longitudinal axis, including an inner shroud and an outer shroud extending coaxially around the longitudinal axis, and structural arms connecting together the inner shroud and the outer shroud, the structural arms extending along a radial axis perpendicular to the longitudinal axis, each structural arm including a leading edge, a trailing edge, an intrados and an extrados, defining together the outer peripheral surface of the structural arm,
wherein the radially inner end of each structural arm is connected to the inner shroud and the radially outer end of each structural arm is connected to the outer shroud, the radially inner end of each structural arm extending between a first inner inflection point of the leading edge of the structural arm located at the junction between the inner shroud and the leading edge of the structural arm and a second inner inflection point of the structural arm located at the junction between the inner shroud and the trailing edge of the structural arm, and the radially outer end of each structural arm extending between a first outer inflection point of the structural arm located at the junction between the outer shroud and the leading edge of the structural arm and a second outer inflection point of the structural arm located at the junction between the outer shroud and the trailing edge of the structural arm, characterized in that each structural arm has a plane, normal to the longitudinal axis, passing through the master cross-section of the structural arm, whose position along the longitudinal axis is determined as follows:
   generating at least one, preferably three, set(s) of cutting points defining together a cross-sectional surface of the structural arm, each set of cutting points being obtained by creating the intersection between the outer peripheral surface of each structural arm and a plurality of cutting planes normal to the longitudinal axis between the leading edge and the trailing edge of the structural arm, the cutting points being each taken radially at a constant flowpath height ratio h/H along the longitudinal axis, H being, in each cutting plane normal to the considered longitudinal axis, the radius difference between the outer shroud and the inner shroud and h being, in each cutting plane normal to the considered longitudinal axis, the radius difference between the height of the cutting point and the radius of the inner shroud, so as to obtain at least one cross-sectional surface with a constant flowpath height ratio, and preferably a first cross-sectional surface with a flowpath height ratio equal to 10%, a second cross-sectional surface with a flowpath height ratio equal to 50%, and a third cross-sectional surface with a flowpath height ratio equal to 90%, each intersection between the outer peripheral surface of each structural arm and one of the cutting planes normal to the longitudinal axis at a flowpath height ratio giving an intrados cutting point located on the intrados side of the structural arm and an extrados cutting point located on the extrados side of the structural arm,
   then, for each cross-sectional surface, inscribing a plurality of cylinders inside the structural arm, each cylinder having a diameter and a generatrix perpendicular to the longitudinal axis and without intersection with the outer peripheral surface of the structural arm, the largest diameter allowing identifying the largest inscribable cylinder which gives, through the axial position of its generatrix, the position along the longitudinal axis of the master cross-section associated with the cross-sectional surface, and preferably at least three positions along the longitudinal axis of the master cross-section each associated with a cross-sectional surface.
   determining the arithmetic mean of the position(s) along the longitudinal axis of the master cross-section to obtain a mean position of the master cross-section along the longitudinal axis defining the master cross-section, the plane passing through the master cross-section being the plane perpendicular to the longitudinal axis and passing through the mean position of the master cross-section at ±2%.
wherein, by observation of each structural arm in a plane defined by the longitudinal axis and the radial axis, perpendicular to the plane passing through the master cross-section, the casing has an aerodynamic flowpath opening at the level of each structural arm defined:
   by an aerodynamic flowpath inner opening which has an inner radial spacing formed between, on the one hand, the junction between the inner shroud and the radially inner end of the structural arm and, on the other hand, the straight line joining the first inner inflection point and the second inner inflection point, and/or
   by an aerodynamic flowpath outer opening which has an outer radial spacing formed between, on the one hand, the junction between the outer shroud and the radially outer end of the structural arm and, on the other hand, the straight line joining the first outer inflection point and the second outer inflection point,
wherein the intersection between the straight line joining the first inner inflection point and the second inner inflection point, and the plane passing through the master cross-section of the structural arm, defines a reference inner radius R_{iRef} along the radial axis,
the intersection between the straight line joining the first outer inflection point and the second outer inflection point, and the plane passing through the master cross-section of the structural arm, defines a reference outer radius R_{eRef} along the radial axis,
the intersection between the junction of the inner shroud with the radially inner end of the structural arm forming the aerodynamic flowpath inner opening, and the plane passing through the master cross-section of the structural arm, defines an inner opening radius Rᵢ₂ along the radial axis,
the intersection between the junction of the outer shroud with the radially outer end of the structural arm forming the aerodynamic flowpath outer opening and the plane passing through the master cross-section of the structural arm, defines an outer opening radius Rₑ₂ along the radial axis;
wherein the method includes a step of dimensioning the casing during which a calculated trailing edge outer flowpath tangent

$${Γ}_{e 2 , BF}^{′}$$

is defined as:

$${Γ}_{e 2 , BF}^{′} = {Γ}_{eRef , BF} - \vert \frac{{R}_{e 2} - {R}_{eRef}}{{x}_{MC} - {x}_{e , BF}} \vert$$

with:

$${Γ}_{eRef , BF} = \frac{{R}_{eRef} - {R}_{e , BF}}{{x}_{MC} - {x}_{e , BF}}$$

where:

$${Γ}_{eRef , BF}$$

is the trailing edge reference outer flowpath tangent, passing through the second outer inflection point of the trailing edge of the structural arm and through the reference outer opening point, located at the reference outer radius R_{eRef} along the radial axis and at the mean position of the master cross-section along the longitudinal axis,
R_{e,BF} is the radius along the radial axis of the second outer inflection point of the trailing edge of the structural arm,
x_{e,BF} is the position along the longitudinal axis of the second outer inflection point of the trailing edge of the structural arm.

In one embodiment, a calculated outer opening radius

$${R}_{e 2}^{′}$$

is defined as:

$${R}_{e 2}^{′} = \frac{- {b}_{e} + \sqrt{{Δ}_{e}}}{2 {a}_{e}}$$

with:

$${Δ}_{e} = {b}_{e}^{2} - 4 {a}_{e} {c}_{e}$$

and:

$${b}_{e} = - \frac{MC}{π} {N}_{b}$$

and:

$${c}_{e} = - ( \frac{χ {S}_{o}}{π} - \frac{MC}{π} {N}_{b} {R}_{eRef} + {R}_{eRef}^{2} )$$

and:

Sₒ=MC(R_{eRef}−R_{iRef})N_{b}
where:
MC is the master cross-section of the structural arm,
N_{b} is the number of structural arms of the casing,
χ is a distribution factor of the obstructed section Sₒ,
aₑ is a predefined coefficient,
the method including a step of dimensioning the casing during which:
R_{eRef} is chosen such that 0.21 m≤R_{eRef}≤0.30 m,
R_{iRef} is chosen such that 0.14 m≤R_{iRef}≤0.23 m,
MC is chosen such that 0.018≤m≤MC≤0.035 m,
Nb is chosen such that 8≤Nb≤24,
Sₒ is chosen such that 0.01 m²≤Sₒ≤0.10 m²,
χ is chosen such that 0≤χ≤1,
aₑ is chosen such that aₑ=1.

In one embodiment, the method includes a step of dimensioning the casing during which the outer opening radius Rₑ₂ is chosen such that

$${R}_{eRef} < {R}_{e 2} \leq {R}_{e 2}^{′} .$$

In one embodiment, the method includes a step of dimensioning the casing during which the outer opening radius Rₑ₂ is chosen such that:

$${R}_{e 2} = {R}_{e 2}^{′} \times \frac{1}{ε}$$

where:
ε is a resetting factor of the radius Rₑ₂ chosen such that 1≤ε≤1.04.

In one embodiment, the method includes a step of dimensioning the casing during which the outer opening radius Rₑ₂ is chosen such that:

$$0.99 \times {R}_{e 2}^{′} \times \frac{1}{ε} \leq {R}_{e 2} \leq 1.01 \times {R}_{e 2}^{′} \times \frac{1}{ε}$$

In one embodiment, a calculated inner opening radius

$${R}_{i 2}^{′}$$

is defined as:

$${R}_{i 2}^{′} = \frac{- {b}_{i} + \sqrt{{Δ}_{i}}}{2 {a}_{i}}$$

with:

$${Δ}_{i} = {b}_{i}^{2} - 4 {a}_{i} {c}_{i}$$

and:

$${b}_{i} = - \frac{MC}{π} {N}_{b}$$

and:

$${c}_{i} = \frac{( 1 - χ ) {S}_{o}}{π} + \frac{MC}{π} {N}_{b} {R}_{iRef} - {R}_{iRef}^{2}$$

where:
aᵢ is a predefined coefficient,
the method including a step of dimensioning the casing during which:
aᵢ is chosen such that aᵢ=1.

In one embodiment, the method includes a step of dimensioning the casing during which the inner opening radius Rᵢ₂ is chosen such that

$${R}_{i 2}^{′} \leq {R}_{i 2} < {R}_{iRef} .$$

In one embodiment, the method includes a step of dimensioning the casing during which the inner opening radius Rᵢ₂ is chosen such that:

$${R}_{i 2} = {R}_{i 2}^{′} \times ε$$

where:
ε is a resetting factor of the radius Rᵢ₂ chosen such that 1≤ε≤1.04.

In one embodiment, the method includes a step of dimensioning the casing during which the inner opening radius Rᵢ₂ is chosen such that:

$$0.99 \times {R}_{i 2}^{′} \times ε \leq {R}_{i 2} \leq 1.01 \times {R}_{i 2}^{′} \times ε$$

In one embodiment, the method includes a step of dimensioning the casing during which a calculated leading edge inner flowpath tangent

$${Γ}_{i 2 , BA}^{′}$$

is defined as:

$${Γ}_{i 2 , BA}^{′} = {Γ}_{iRef , BA} - \vert \frac{{R}_{i 2} - {R}_{iRef}}{{x}_{MC} - {x}_{i , BA}} \vert$$

with:

$${Γ}_{iRef , BA} = \frac{{R}_{iRef} - {R}_{i , BA}}{{x}_{MC} - {x}_{i , BA}}$$

where:
Γ_{iRef,BA} is the leading edge reference inner flowpath tangent, passing through the first inner inflection point of the leading edge of the structural arm and through the reference inner opening point, located at the reference inner radius R_{iRef} along the radial axis and at the mean position of the master cross-section along the longitudinal axis,
R_{i,BA} is the radius along the radial axis of the first inner inflection point of the leading edge of the structural arm,
x_{i,BA} is the position along the longitudinal axis of the first inner inflection point of the leading edge of the structural arm.

In one embodiment, the method includes a step of dimensioning the casing during which the leading edge inner flowpath tangent Γ_{i2,BA}, passing through the first inner inflection point of the leading edge of the structural arm and through the inner opening point, located at the inner opening radius Rᵢ₂ and at the mean position of the master cross-section along the longitudinal axis, is chosen such that

$$0.95 \times {Γ}_{i 2 , BA}^{′} \leq {Γ}_{i 2 , BA} < {Γ}_{iRef , BA}$$

In one embodiment, the method includes a step of dimensioning the casing during which a calculated leading edge outer flowpath tangent

$${Γ}_{e 2 , BA}^{′}$$

is defined as:

$${Γ}_{e 2 , BA}^{′} = {Γ}_{eRef , BA} + \vert \frac{{R}_{e 2} - {R}_{eRef}}{{x}_{MC} - {x}_{e , BA}} \vert$$

with:

$${Γ}_{eRef , BA} = \frac{{R}_{eRef} - {R}_{e , BA}}{{x}_{MC} - {x}_{e , BA}}$$

where:
Γ_{eRef,BA} is the leading edge reference outer flowpath tangent, passing through the first outer inflection point of the leading edge of the structural arm and through the reference outer opening point, located at the reference outer radius R_{eRef} along the radial axis and at the mean position of the master cross-section along the longitudinal axis,
R_{e,BA} is the radius along the radial axis of the first outer inflection point of the leading edge of the structural arm,
x_{e,BA} is the position along the longitudinal axis of the first outer inflection point of the leading edge of the structural arm.

In one embodiment, the method includes a step of dimensioning the casing during which the leading edge outer flowpath tangent Γ_{e2,BA}, passing through the first outer inflection point of the leading edge of the structural arm and through the outer opening point, located at the outer opening radius Rₑ₂ and at the mean position of the master cross-section along the longitudinal axis, is chosen such that:

$${Γ}_{eRef , BA} < {Γ}_{e 2 , BA} \leq 1.05 \times {Γ}_{e 2 , BA}^{′}$$

In one embodiment, the method includes a step of dimensioning the casing during which a calculated trailing edge inner flowpath tangent

$${Γ}_{i 2 , BF}^{′}$$

is defined as:

$${Γ}_{i 2 , BF}^{′} = {Γ}_{iRef , BF} + \vert \frac{{R}_{i 2} - {R}_{iRef}}{{x}_{MC} - {x}_{i , BF}} \vert$$

with:

$${Γ}_{iRef , BF} = \frac{{R}_{iRef} - {R}_{i , BF}}{{x}_{MC} - {x}_{i , BF}}$$

where:
Γ_{iRef,BF} is the trailing edge reference inner flowpath tangent, passing through the second inner inflection point of the trailing edge of the structural arm and through the reference inner opening point, located at the reference inner radius R_{iRef} along the radial axis and at the mean position of the master cross-section along the longitudinal axis,
R_{i,BF} is the radius along the radial axis of the second inner inflection point of the trailing edge of the structural arm,
X_{i,BF} is the position along the longitudinal axis of the second inner inflection point of the trailing edge of the structural arm.

In one embodiment, the method includes a step of dimensioning the casing during which the trailing edge inner flowpath tangent Γ_{i2,BF}, passing through the second inner inflection point of the trailing edge of the structural arm and through the inner opening point, located at the inner opening radius Rᵢ₂ and at the mean position of the master cross-section along the longitudinal axis, is chosen such that:

$${Γ}_{iRef , BF} < {Γ}_{i 2 , BF} \leq 1.05 \times {Γ}_{i 2 , BF}^{′}$$

In one embodiment, the method includes a step of dimensioning the casing during which the trailing edge outer flowpath tangent Γ_{e2,BF}, passing through the second outer inflection point of the trailing edge of the structural arm and through the outer opening point, located at the outer opening radius Rₑ₂ and at the mean position of the master cross-section along the longitudinal axis, is chosen such that:

$$0.95 \times {Γ}_{e 2 , BF}^{′} \leq {Γ}_{e 2 , BF} < {Γ}_{eRef , BF}$$

In one embodiment, the aerodynamic flowpath opening has, by sectional observation in a plane defined by the tangential axis and the radial axis at the level of the plane passing through the master cross-section of the structural arm, an outer circular ring representing the excess section related to the aerodynamic flowpath opening relative to the section obstructed by the structural arm, the outer circular ring being defined as:

$$Δ {S}_{e} = π ( {R}_{e 2}^{2} - {R}_{eRef}^{2} ) - MC ( {R}_{e 2} - {R}_{eRef} ) {N}_{b} = χ {S}_{o}$$

the method including a step of dimensioning the casing during which the parameter ΔSₑ is chosen such that ΔSₑ is strictly greater than 0% and strictly less than 100% of the obstructed section Sₒ.

In one embodiment, the method includes a step of dimensioning the casing during which the parameter ΔSₑ is chosen such that ΔSₑ is comprised between 40% and 60% of the obstructed section Sₒ.

In one embodiment, the aerodynamic flowpath opening has, by sectional observation in a plane defined by the tangential axis and the radial axis at the level of the plane passing through the master cross-section of the structural arm, an inner circular ring representing the excess section related to the aerodynamic flowpath opening relative to the section obstructed by the structural arm, the inner circular ring being defined as:

$$Δ {S}_{i} = π ( {R}_{iRef}^{2} - {R}_{i 2}^{2} ) - MC ( {R}_{iRef} - {R}_{i 2} ) {N}_{b} = ( 1 - χ ) {S}_{o}$$

the method including a step of dimensioning the casing during which the parameter ΔSᵢ is chosen such that ΔSᵢ is strictly greater than 0% and strictly less than 100% of the obstructed section Sₒ.

In one embodiment, the method includes a step of dimensioning the casing during which the parameter ΔSᵢ is chosen such that ΔSᵢ is comprised between 40% and 60% of the obstructed section Sₒ.

Furthermore, the invention also relates, according to another of its aspects, to a turbomachine casing manufactured from a dimensioning method as defined previously.

### PRESENTATION OF THE DRAWINGS

Other characteristics and advantages will become clearer from the following description, which is purely illustrative and not exhaustive, and should be read in relation to the appended figures, among which:

FIG. 1 schematically represents an aircraft comprising turbomachines or propulsion systems,

FIG. 2 schematically represents, in partial and sectional view, one example of a turbomachine in which the fan section is ducted,

FIG. 3 schematically represents, in partial and sectional view, one example of a turbomachine in which the fan section is unducted,

FIG. 4 schematically and partially represents one example of a turbomachine inter-turbine casing,

FIG. 5 schematically and partially represents, in axial section, an inter-turbine casing in accordance with the invention at the level of a structural arm with an aerodynamic flowpath opening,

FIG. 6 is a view along VI-VI of FIG. 5,

FIG. 7 schematically and partially represents, in perspective, one example of a current sheet and structural arm along the engine axis;

FIG. 8 schematically and partially represents, in radial section, one example of a master cross-section of a structural arm of an inter-turbine casing, and

FIGS. 9 to 18 schematically and partially represent various sectional or perspective views illustrating the method for determining the plane passing through the master cross-section of a structural arm, and

FIG. 19 schematically and partially represents, in axial section, a view similar to that of FIG. 5 of an inter-turbine casing in accordance with the invention at the level of a structural arm with an aerodynamic flowpath opening, allowing the visualization of the tangents or slopes at the level of the upstream and downstream flowpaths, on the inner side and the outer side.

Throughout these figures, identical reference numerals may designate identical or analogous elements.

in addition, the different parts represented in the figures are not necessarily represented on a uniform scale, to make the figures more legible.

### DETAILED DESCRIPTION OF EMBODIMENTS

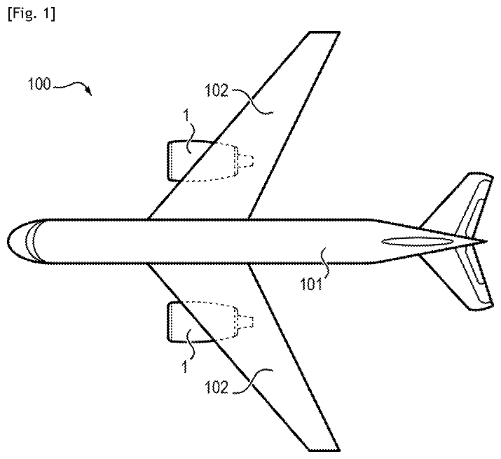

In the example illustrated in FIG. 1, the aircraft is an airplane 100 comprising a fuselage 101 and two wings 102. In this example, the aircraft comprises two turbomachines or propulsion systems 1, each propulsion system 1 being fixed to a respective wing 102 of the airplane 100 by means of a pylon. In another embodiment, the aircraft could comprise one or more propulsion system(s) fixed to the fuselage 101.

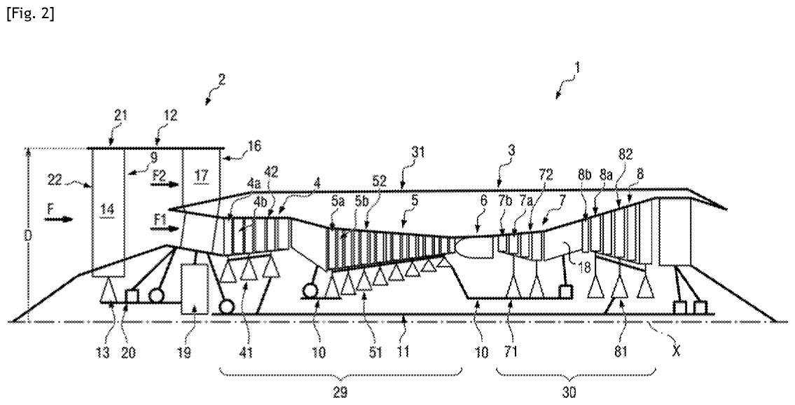

FIG. 2 schematically represents, in partial and sectional view, a first example of a propulsion system 1.

In this example, the propulsion system 1 is a turbomachine in the form of a twin-spool and ducted-fan gas turbine engine.

In FIG. 2, the propulsion system 1 has a principal direction extending along a longitudinal axis X. The propulsion system 1 comprises a fan section 2 and a primary body 3, often called “gas generator”.

The fan section 2 comprises a fan 22 and a fan casing 12. The fan 22 comprises a fan rotor 9. The fan casing 12 encloses the fan rotor 9. The fan rotor 9 is rotatably mounted relative to the fan casing 12.

The fan rotor 9 comprises a fan hub 13 and fan vanes 14 extending radially from the hub 13. The fan vanes 14 may be fixed relative to the fan hub 13 or have variable setting. In this latter case, each of the fan vanes 14 is pivotally mounted relative to the fan hub 13 along a setting axis and is connected to a pitch-change mechanism (not represented) mounted in the propulsion system 1. The pitch-change mechanism allows adjusting the setting angle of the fan vanes 14 according to the flight phases.

The fan rotor 9 comprises at least fourteen fan vanes 14 and at most twenty-four fan vanes 14, preferably at least sixteen fan vanes 14 and at most twenty-two fan vanes 14.

In addition, in this example, the fan section 2 also comprises a fan stator 16 fixedly mounted on the fan casing 12. The fan stator 16 comprises vanes 17 generally referred to as “outlet guide vanes” (or “OGVs”). This set of vanes has the function of straightening and regulating the air stream that flows downstream of the fan rotor 9 to contribute to the thrust of the engine. This set of vanes also plays a noise reduction role.

Alternatively, the outlet vanes 17 could have a variable setting. If so, and similarly to the fan vanes 14 of the fan rotor 9, the root of the outlet vanes 17 is pivotally mounted following a setting axis and is connected to a pitch-change mechanism (not represented), the setting being adjusted according to the flight phases by the pitch-change mechanism.

The number of outlet vanes 17 depends on the acoustic criteria defined for the propulsion system 1 and is at least equal to the number of fan vanes 14.

The primary body 3 comprises a compressor section 29, a combustion chamber 6, and a turbine section 30.

The compressor section 29 comprises a low-pressure compressor 4 and a high-pressure compressor 5.

The low-pressure compressor 4 comprises a rotor 41 specific to be driven in rotation relative to the casing 31 of the propulsion system 1 and a stator 42 fixedly mounted on the casing 31.

The rotor 41 of the low-pressure compressor 4 comprises movable wheels 4a, and the stator 42 of the low-pressure compressor 4 comprises fixed wheels 4b. The movable wheels 4a are disposed alternately with the fixed wheels 4b, thus forming a series of low-pressure compressor stages.

Similarly, the high-pressure compressor 5 comprises a rotor 51 specific to be driven in rotation relative to the casing 31 of the propulsion system 1 and a stator 52 fixedly mounted on the casing 31.

The rotor 51 of the high-pressure compressor 5 comprises movable wheels 5a, and the stator 52 of the high-pressure compressor 5 comprises fixed wheels 5b. The movable wheels 5a are disposed alternately with the fixed wheels 5b, thus forming a series of high-pressure compressor stages.

The turbine section 30 comprises, firstly, a high-pressure turbine 7 and a low-pressure turbine 8.

The high-pressure turbine 7 comprises a rotor 71 specific to be driven in rotation relative to the casing 31 of the propulsion system 1 and a stator 72 fixedly mounted on the casing 31.

The rotor 71 of the high-pressure turbine 7 comprises movable wheels 7a, and the stator 72 of the high-pressure turbine 7 comprises fixed wheels 7b. The movable wheels 7a are disposed alternately with the fixed wheels 7b, thus forming a series of high-pressure turbine stages.

Similarly, the low-pressure turbine 8 comprises a rotor 81 specific to be driven in rotation relative to the casing 31 of the propulsion system 1, and a stator 82 fixedly mounted on the casing 31.

The rotor 81 of the low-pressure turbine 8 comprises movable wheels 8a, and the stator 82 of the low-pressure turbine 8 comprises fixed wheels 8b. The movable wheels 8a are disposed alternately with the fixed wheels 8b, thus forming a series of low-pressure turbine stages.

The propulsion system 1 further comprises an inter-turbine casing 18 disposed between the high-pressure turbine 7 and the low-pressure turbine 8. More specifically, the inter-turbine casing 18 connects the stator or casing 72 of the high-pressure turbine 7 to the stator or casing 82 of the low-pressure turbine 8. The high-pressure turbine 7, the low-pressure turbine 8 and the inter-turbine casing 18 form together the turbine section 30 of the propulsion system 1.

The propulsion system 1 comprises a low-pressure shaft 11 connecting the rotor 41 of the low-pressure turbine 4 to the rotor 81 of the low-pressure compressor 8, the low-pressure shaft 11 being rotatably mounted relative to the casing 31 around the longitudinal axis X.

When the propulsion system 1 is in operation, the rotor 81 of the low-pressure turbine 8 drives in rotation the rotor 41 of the low-pressure compressor 4 via the low-pressure shaft 11.

The propulsion system 1 further comprises a fan shaft 20 and a reduction mechanism 19. The fan rotor 9 is fixedly mounted on the fan shaft 20. The reduction mechanism 19 has an inlet and an outlet. The inlet of the reduction mechanism 19 is connected to the low-pressure shaft 11, and the outlet of the reduction mechanism 19 is connected to the fan shaft 20. Thus, when the propulsion system 1 is in operation, the rotor 81 of the low-pressure turbine 8 drives in rotation not only the rotor 41 of the low-pressure compressor 4, but also the fan rotor 9, via the low-pressure shaft 11, the reduction mechanism 19, and the fan shaft 20.

Thanks to the reduction mechanism 19, the fan rotor 9 is driven in rotation at a speed lower than the rotational speed of the rotor 41 of the low-pressure turbine 4.

The reduction mechanism 19 thus allows independently controlling the rotational speed of the fan 22 and the rotational speed of the low-pressure turbine 8 and of the low-pressure compressor 4.

The low-pressure turbine 8, the low-pressure shaft 11, the low-pressure compressor 4, the fan shaft 20, the reduction mechanism 19, and the fan 22 form together the “low-pressure body” of the propulsion system 1.

The propulsion system 1 further comprises a high-pressure shaft 10 connecting the rotor 51 of the high-pressure turbine 5 to the rotor 71 of the high-pressure compressor 7, the high-pressure shaft 10 being rotatably mounted relative to the casing 31 around the longitudinal axis X. The high-pressure shaft 10 is coaxial with the low-pressure shaft 11 and extends around the low-pressure shaft 11.

When the propulsion system 1 is in operation, the rotor 81 of the low-pressure turbine 8 drives in rotation the rotor 51 the low-pressure compressor 5 through the low-pressure shaft 11.

The high-pressure turbine 7, the high-pressure shaft 10 and the high-pressure compressor 4 form together the “high-pressure body” of the propulsion system 1.

The low-pressure shaft 11 and the high-pressure shaft 10 can be co-rotating, that is to say driven in the same direction of rotation around the longitudinal axis X. as a variant, the low-pressure shaft 11 and the high-pressure shaft 10 can be contra-rotating, that is to say driven in opposite directions of rotation around the longitudinal axis X.

The twin-spool propulsion system 1 can in particular comprise a single-stage high-pressure turbine 7 that is to say comprising exactly one stage, or a two-stage high-pressure turbine 7 that is to say comprising exactly two stages (as illustrated in the example in FIG. 2).

The high-pressure compressor 5 comprises at least eight stages (as illustrated in the example in FIG. 2) and at most eleven stages.

The low-pressure turbine 8 comprises at least three stages (as illustrated in the example of FIG. 2) and at most seven stages.

The low-pressure compressor 4 comprises at least two stages and at most four stages.

When the propulsion system is in operation, an air stream F entering the propulsion system 1 passes through the fan 22 and is then split between a primary air stream F1 and a secondary air stream F2, which circulate from upstream to downstream in the propulsion system 1.

The secondary air stream F2, also called “bypass air stream”, flows in the secondary flowpath around the primary body 3. The secondary air stream F2 allows cooling the periphery of the primary body 3 and generates most of the thrust provided by the propulsion system 1.

The primary air stream F1 flows in a primary flowpath inside the primary body 3, by passing successively through the compressor section 29 (low-pressure compressor 4 and high-pressure compressor 5), the combustion chamber 6 where it is mixed with fuel to act as an oxidizer, and the turbine section 30 (high-pressure turbine 7 and low-pressure turbine 8). The passage of the primary air stream F1 through the turbine section 30, receiving energy from the combustion chamber 6, causes a rotation of the movable wheels 7a, 8a of the turbine section 30, which in turn drive in rotation the movable wheels 4a, 5a of the compressor section 29, as well as the fan rotor 9.

In order to improve the propulsive efficiency of the propulsion system 1 and reduce its specific consumption as well as the noise emitted by the fan section 2, the propulsion system 1 has a high bypass ratio. By “high” bypass ratio it is meant a bypass ratio greater than or equal to 10, for example comprised between 10 and 80 inclusive, preferably comprised between 10 and 35 inclusive, preferably between 10 and 18 inclusive. The bypass ratio is defined as a ratio between the mass flow rate of the secondary air stream F2 and the mass flow rate of the primary air stream F1, these mass flow rates being measured when the propulsion system 1 is stationary, uninstalled, in take-off rating in a standard atmosphere (as defined by the International Civil Aviation Organization (ICAO) manual, Doc 7488/3, 3^{rd} edition) and at sea level. By “Uninstalled” it is meant that the measurements are performed when the propulsion system 1 is in a test bench (and not installed on an aircraft), as the measurements are then simpler to perform.

In a propulsion system including a reduction mechanism 19 such as the one illustrated in FIG. 2, the decoupling between the rotational speed of the fan 22 and the rotational speed of the low-pressure turbine 8 allows reducing the rotational speed and the pressure ratio of the fan rotor 9 while increasing the power extracted by the low-pressure turbine 8. Indeed, the overall efficiency of the propulsion system 1 is conditioned to the first order by the propulsive efficiency, which is favorably influenced by minimizing the variation of the kinetic energy of the air upon passing through the propulsion system 1. In a propulsion system with a high bypass ratio, most of the flow rate generating the propulsive force is constituted by the secondary air stream F2 of the propulsion system 1, the kinetic energy of the secondary air stream F2 being mainly affected by the compression that the secondary air stream F2 undergoes when passing through the fan section 2. The propulsive efficiency and the pressure ratio of the fan section 2 are therefore linked: the lower the pressure ratio of the fan section 2, the better the propulsive efficiency. In order to improve the propulsive efficiency of the propulsion system 1, the fan pressure ratio, which corresponds to the ratio between the mean pressure at the outlet of the fan stator 16 (or, in the absence of a stator 16, of the fan rotor 9) and the mean pressure at the inlet of the fan rotor 9, is less than or equal to 1.70, preferably less than or equal to 1.50, for example comprised between 0.90 and 1.45. The mean pressures are measured here over the height of at least one of the fan vanes 14 that is to say from the surface that radially delimits, inside, the air flowpath at the inlet of the fan rotor 9 to the tip 21 of the fan vane 14.

The peripheral speed at the tip 21 of the fan vanes 14 can also be comprised between 260 meters per second (m·s⁻¹) and 400 meters per second (m·s⁻¹) inclusive. The fan pressure ratio can then be comprised between 1.20 and 1.45.

In a direct-drive propulsion system, the fan rotor 9 can alternatively be directly coupled to the low-pressure shaft 11 that is to say without a reduction mechanism. The low-pressure shaft 11 is then coincident with the fan shaft 20 so that the fan rotor 9 is driven by the low-pressure shaft 11 at the same rotational speed as the rotor 81 of the low-pressure turbine 8.

The propulsion system 1 is configured to provide a thrust comprised between 18,000 lbf (80,068 N) and 51,000 lbf (226,859 N), preferably betwenn 20,000 lbf (88,964 N) and 35,000 lbf (155,688 N).

The diameter D of the fan rotor 9 can be comprised between 80 inches (203.2 cm) and 185 inches (469.9 cm) inclusive. When the fan rotor 9 is ducted, the diameter D is preferably comprised between 85 inches (215.9 cm) and 120 inches (304.8 cm) inclusive, for example of the order of 90 inches (228.6 cm), which allows for the integration of the propulsion system 1 in a conventional manner, particularly under a wing of the aircraft 1.

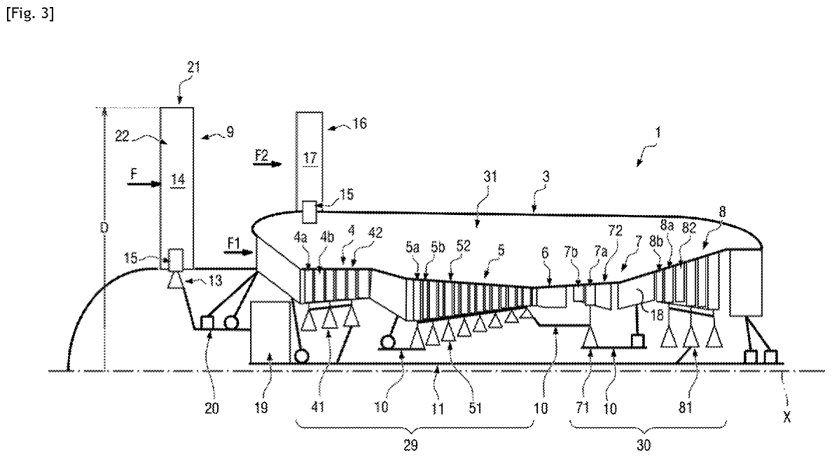

FIG. 3 schematically represents, in partial and sectional view, a second example of a propulsion system 1.

In FIG. 3, the components identical or similar to those of the propulsion system in FIG. 2 are designated by identical reference numerals.

In the example illustrated in FIG. 3, the propulsion system 1 is a turbomachine in the form of a twin-spool and unducted-fan gas turbine engine. This could be a gas turbine engine of the Open Rotor or Unducted Single Fan type.

Unlike the first example of FIG. 2, the fan rotor 9, which can also be referred to as “propeller”, is not enclosed by a fan casing.

Since the fan section 2 is unducted, the fan vanes 14 have a variable setting. Thus, each of the fan vanes 14 is pivotally mounted relative to the fan hub 13 along a setting axis and is connected to a pitch-change mechanism 15 mounted in the propulsion system 1. The pitch-change mechanism allows adjusting the setting angle of the fan vanes 14 according to the flight phases. Similarly, the outlet vanes 17 have a variable setting, the root of the outlet vanes 17 being pivotally mounted along a setting axis and connected to a pitch-change mechanism 15, the setting being adjusted according to the flight phases by the pitch-change mechanism.

Alternatively, the propulsion system 1 could comprise two unducted and contra-rotating fan rotors 9. Such a propulsion system 1 is known by the acronym “CROR” for Contra-Rotating Open Rotor or “UDF” for Unducted Double Fan. The fan rotors 9 can be placed downstream of the primary body 3 so as to be of the pusher type or upstream of the primary body 3 so as to be of the puller type).

The absence of a fairing around the fan rotor 9 allows significantly increasing the bypass ratio without the propulsion system 1 being penalized by the mass of the casings 12 or nacelles intended to enclose the fan section 2. The bypass ratio of the propulsion system 1 comprising an unducted fan section 2 is thus greater than or equal to 40, for example comprised between 40 and 80 inclusive. Furthermore, the peripheral speed at the tip 21 of the fan vanes 14 of the fan rotor(s) 9 can be comprised between 210 meters per second (m·s⁻¹) and 260 meters per second (m·s⁻¹) inclusive. The fan pressure ratio can then be preferably comprised between 0.90 and 1.20 inclusive.

The diameter D of the fan rotor 9 can be comprised between 80 inches (203.2 cm) and 185 inches (469.9 cm) inclusive. When the rotor 9 is unducted, the diameter D is preferably greater than or equal to 100 inches (254 cm), for example between 120 inches (304.8 cm) and 156 inches (396.2 cm). The diameter of the fan rotor 9 is measured here in a plane normal to the longitudinal axis X, which is the axis of rotation of the fan rotor 9, at the level of an intersection between a tip 21 and a leading edge 22 of the fan vanes 14.

It should be noted that, since FIG. 2 and FIG. 3 are partial views, the diameter D is only partially visible.

The reduction mechanism 19 may comprise a planetary, star or differential reduction mechanism, with a single stage also called one-stage mechanism or with multiples stages in particular two stages also called dual-stage mechanism.

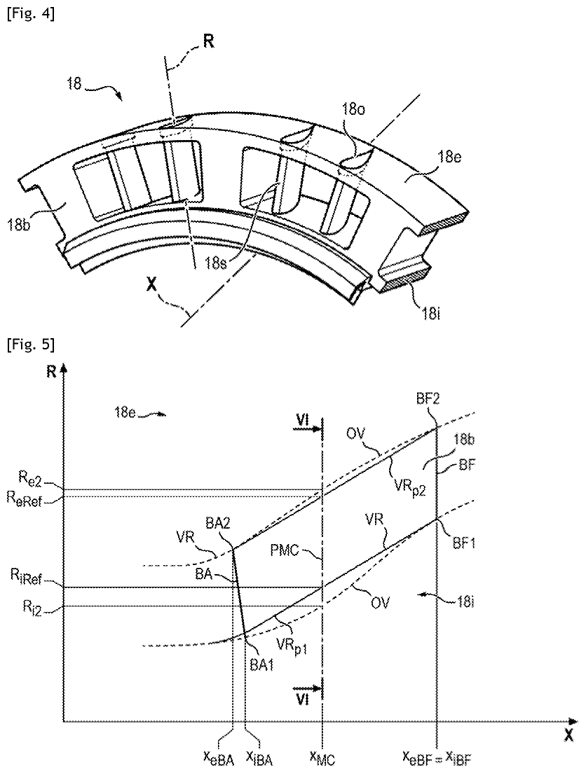

FIG. 4 schematically and partially represents one example of an inter-turbine casing 18, or TVF (Turbine Vane Frame) casing, which includes an inner shroud 18i or hub, an outer shroud 18e and structural arms or thick arms 18b extending radially between the inner shroud 18i and the outer shroud 18e. The inner shroud 18i and the outer shroud 18e extend coaxially around the longitudinal axis X.

The outer shroud 18e includes a plurality of openings 18o, each intended to receive the tip of a splitter vane 18s. The splitter vanes 18s are arranged circumferentially between two circumferentially adjacent structural arms 18b. Of course, this exemplary embodiment is in no way exhaustive, and other configurations could be envisaged, in particular relative to the relative positioning of the thick arms 18b and of the splitter vanes 18s. In addition, although FIG. 4 does not show it, the structural arms 18b can have a vane shape with a leading edge, a trailing edge, an intrados and an extrados.

A radially inner end of the thick arm 18b is connected to the inner shroud 18i, and a radially outer end of the thick arm 18b is connected to the outer shroud 18e.

The structural arms 18b connect together the inner shroud 18i and the outer shroud 18e and extend along a radial axis R perpendicular to the longitudinal axis. X.

Such a casing 18 has a complex design due to the multiple fulfilled functions: the thick arms 18b ensure the structural function of passing the mechanical forces, integrating ancillaries and the aerodynamic function, while the splitter vanes 18s ensure the aerodynamic function of deflecting the flow coming from the high-pressure turbine 7.

Since such an inter-turbine casing 18 contributes to the proper aerodynamic operation of the low-pressure turbine 8, and therefore to the performance of the propulsion system 1, it is necessary to improve its performance. To do so, it is necessary to be able to design an inter-turbine casing 18 with the lowest possible pressure drops.

in order to reduce these pressure drops, it is possible to open the aerodynamic flowpath section at the level of the master cross-section MC of the thick arms 18b in order to reduce the acceleration generated by the obstruction of the thick arms 18b, as well as the Mach level and consequently the pressure drops.

Within the framework of the design of the low-pressure turbines 8 and of the inter-turbine casings 18, the invention thus allows meeting an aerodynamic flowpath section opening criterion that allows reducing the acceleration and the Mach generated by the obstruction of the thick arms 18b to reduce the pressure drops of the inter-turbine casing 18 and thus improve the efficiency of the low-pressure turbine and therefore reduce the fuel consumption and the emissions of the engine.

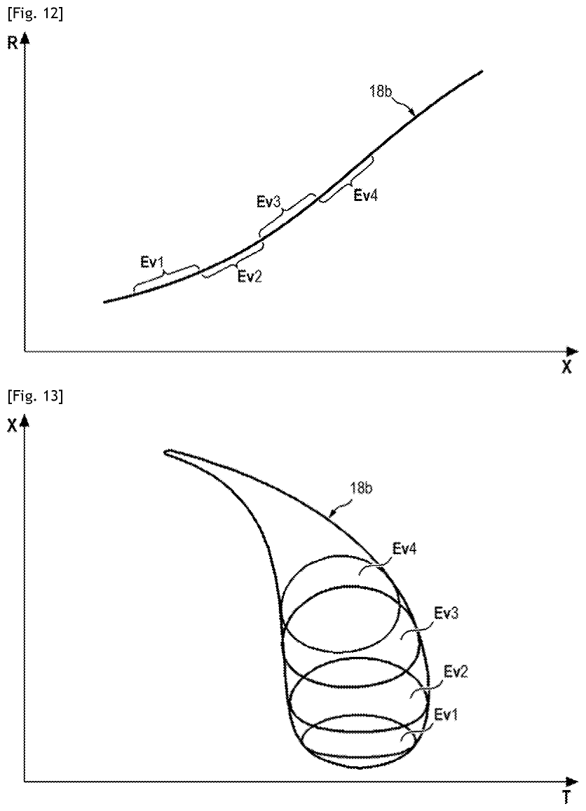

The following FIGS. 5 to 18 define the parameters that allow defining an aerodynamic flowpath section opening criterion that allows reducing the pressure drops.

FIG. 5 is a schematic view, in axial section, of an inter-turbine casing at the level of a radial structural connecting arm 18b, called “thick arm” that allows visualizing, in dashed lines, the aerodynamic flowpath opening OV envisaged by the present invention relative to a fictitious flowpath, in a solid line, which serves as a reference aerodynamic flowpath VR.

In FIG. 5, the trailing edge of the thick arm 18b is represented by the reference BF and the leading edge of the thick arm 18b is represented by the reference BA. In addition, R denotes the radial direction, and X denotes the engine axis, namely the axial or longitudinal direction. The plane passing through the master cross-section MC of the thick arm 18b, normal to the longitudinal axis X, is designated by the reference PMC.

The radially inner end of each structural arm 18b extends between a first inner inflection point BA1 of the leading edge BA of the structural arm 18b, located at the junction between the inner shroud 18i and the leading edge BA of the structural arm 18b, and a second inner inflection point BF1 of the structural arm 18b located at the junction between the inner shroud 18i and the trailing edge BF of the structural arm 18b.

Similarly, the radially outer end of each structural arm 18b extends between a first outer inflection point BA2 of the structural arm 18b located at the junction between the outer shroud 18e and the leading edge BA of the structural arm 18b, and a second outer inflection point BF2 of the structural arm 18b located at the junction between the outer shroud 18e and the trailing edge BF of the structural arm 18b.

The reference aerodynamic flowpath VR is constructed so that its outer wall VRp2 and its inner wall VRp1 are as linear and straight as possible at the level of the thick arm 18b. This construction allows, on the one hand, not modifying the flowpath upstream of the inflection points or corner points BA1 and BA2 of the leading edge BA and downstream of the inflection points or corner points BF1 and BF2 of the trailing edge BF and, on the other hand, ensuring a continuity in tangency and curvature with the elements upstream of the corner points BA1 and BA2 of the leading edge BA and downstream of the corner points BF1 and BF2 of the trailing edge BF of the thick arm 18b.

As visible in FIG. 5, the casing 18 has an aerodynamic flowpath opening OV at the level of the structural arm 18b defined by an aerodynamic flowpath inner opening with an inner radial spacing formed between, on the one hand, the junction between the inner shroud 18i and the radially inner end of the structural arm 18b and, on the other hand, the straight line VRp1 joining the first inner inflection point BA1 and the second inner inflection point BF1, and by an aerodynamic flowpath outer opening with an outer radial spacing formed between, on the one hand, the junction between the outer shroud 18e and the radially outer end of the structural arm 18b and, on the other hand, the straight line VRp2 joining the first outer inflection point BA2 and the second outer inflection point BF2.

The straight line VRp1 is defined by a reference inner radius R_{iRef} along the radial axis R. The straight line VRp2 is defined by a reference outer radius R_{eRef} along the radial axis R. The junction between the inner shroud 18i and the radially inner end of the structural arm 18b forming the aerodynamic flowpath inner opening OV is defined by an inner opening radius Rᵢ₂ along the radial axis R. Finally, the junction between the outer shroud 18e and the radially outer end of the structural arm 18b forming the aerodynamic flowpath outer opening OV is defined by an outer opening radius Rₑ₂ along the radial axis R.

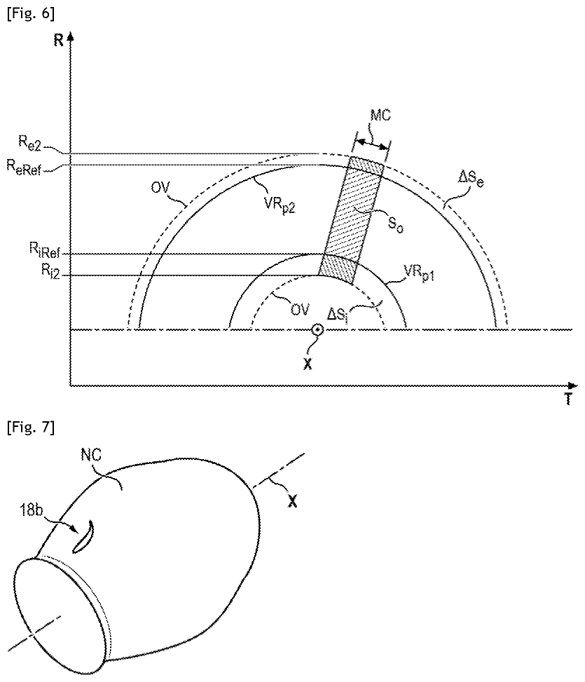

FIG. 6 is a view along VI-VI of FIG. 5, namely a tangential sectional schematic view of the inter-turbine casing of FIG. 5. FIG. 6 thus represents the aerodynamic flowpath opening OV on a plane PMC normal to the engine axis X passing through the master cross-section MC of the thick arm 18b. In FIG. 6, the hatched area corresponds to the section obstructed Sₒ by the thick arm 18b.

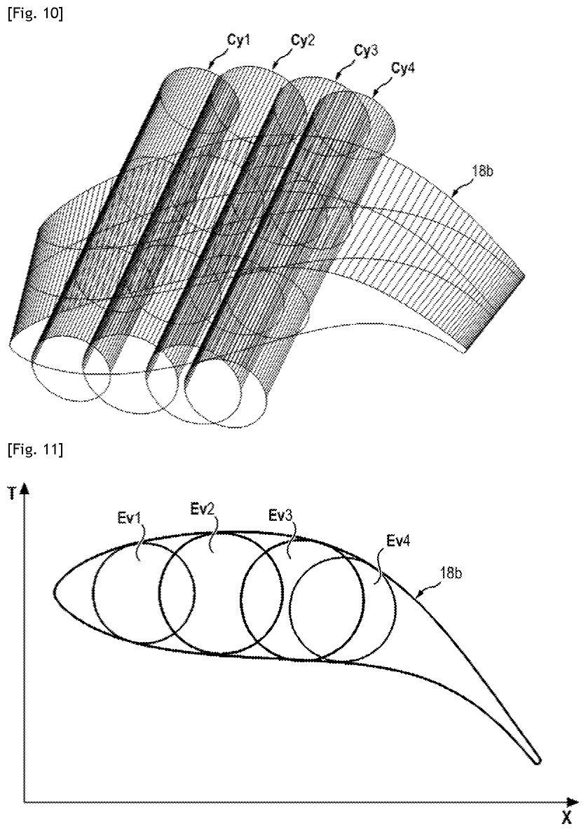

The master cross-section MC of the thick arm 18b corresponds to the axial position of the axis or generatrix of the bulkiest cylinder inscribed within the thick arm 18b, as explained later with reference to FIGS. 10 to 16. FIGS. 7 to 18 allow defining this master cross-section MC and the plane PMC.

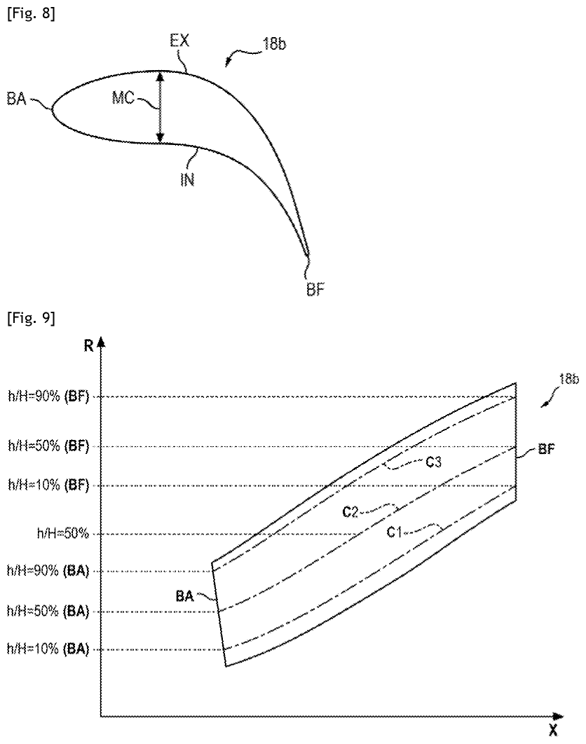

Thus, FIG. 7 schematically represents, in perspective, one example of a current sheet and of thick arms 18b along the engine axis X, and FIG. 8 schematically represents, in radial section, one example of a thick arm 18b. In FIG. 8, the intrados is represented by the reference IN and the extrados is represented by the reference EX. The master cross-section MC of the thick arm 18b can thus be defined as the average of the maximum thicknesses at the root (10% of the radial height), middle (50% of the radial height), and top (90% of the radial height) of the thick arm 18b on sections between the volume of the thick arm 18b and the current sheets NC at 10%, 50% and 90% of the flowpath height.

The position of the plane PMC, visible in FIG. 5, passing through the master cross-section MC of the thick arm 18b is a right plane perpendicular to the engine axis X differentiating the reference radii and the new radii to be applied, described subsequently, to create the section opening. This position can vary around the mean position x_{MC} of the master cross-section of the thick arm 18b within a range of ±2.5%, this mean position being defined by the arithmetic mean of the position of the master cross-section MC at the root, middle and tip of the thick arm 18b, as described in more detail below with reference to FIGS. 9 to 18.

These FIGS. 9 to 18 allow more accurately presenting the method for determining the construction of the plane PMC passing through the master cross-section MC. The construction of the plane PMC is carried out in two steps: estimating the master cross-section MC of the thick arm 18b on sections at 10%, 50% and 90% of the aerodynamic flowpath height; then estimating the mean position x_{MC} of the master cross-section MC over the height, giving the position of the plane PMC.

The first step of estimating the master cross-section MC on sections at 10%, 50% and 90% of the flowpath height is described below with reference to FIGS. 9 to 16. Thus, before estimating the master cross-section MC of the thick arm 18b, it is necessary to cut it at 10%, 50% and 90% of the flowpath height, namely to generate sections with constant height (sections with a constant h/H ratio) and constant radius. Specifically, three sets of cutting points are here generated, defining together a cross-sectional surface C1, C2, C3 of the structural arm 18b, each set of cutting points being obtained by creating the intersection between the outer peripheral surface of each structural arm 18b and a plurality of cutting planes normal to the longitudinal axis X. The cutting points are each taken radially at a constant flowpath height ratio h/H on the longitudinal axis X, H being, in each cutting plane normal to the considered longitudinal axis X, the radius difference between the outer shroud 18e and the inner shroud 18i and h being, in each cutting plane normal to the considered longitudinal axis X, the radius difference between the height of the cutting point and the radius of the inner shroud 18i. It should be noted that each intersection between the outer peripheral surface of each structural arm 18b and one of the cutting planes normal to the longitudinal axis X at a flowpath height ratio h/H gives an intrados cutting point located on the intrados side IN of the structural arm 18b and an extrados cutting point located on the extrados side EX of the structural arm 18b.

These cross-sectional surfaces C1, C2, C3 are made from the leading edge BA to the trailing edge BF. FIG. 9 allows visualizing the cutting of the thick arm 18b with these cutting surfaces C1, C2, C3 at a constant h/H ratio. Here, three cutting surfaces C1, C2 and C3 corresponding respectively to sections at h/H=10%, h/H=50%, and h/H=90% are obtained.

Once these sectional surfaces C1, C2, C3 are available, the estimation of the position of the master cross-section MC is made by inscribing, for each cross-sectional surface C1, C2, C3, a plurality of cylinders Cy1, Cy2, Cy3, Cy4, whose number is a function of what can be passed inside the thick arm 18b, as visible in FIG. 10 in perspective. These cylinders Cy1, Cy2, Cy3, Cy4 must have a generatrix perpendicular to the longitudinal axis X and entirely located inside the thick arm 18b, and must have the largest possible diameters so as to be tangent to the thick arm 18b without intersecting it at the level of the cutting surface C1, C2, C3 at a constant h/H ratio on which the master cross-section MC is estimated. It should be noted that these cylinders could intersect the thick arm 18b at different h/H ratios than those considered here (10%, 50%, 90%) for the evaluation of the master cross-section MC. The intersection between the cylinders Cy1, Cy2, Cy3, Cy4 and the cross-sectional surfaces C1, C2, C3 at a predefined h/H ratio leads to obtaining a shell such as is visible in section in FIGS. 11, 12 and 13 along the three planes defined by the longitudinal X, radial R and tangential T axes. Shell elements Ev1, Ev2, Ev3, Ev4 which can, where applicable, take the form of circles or ellipses are then observed.

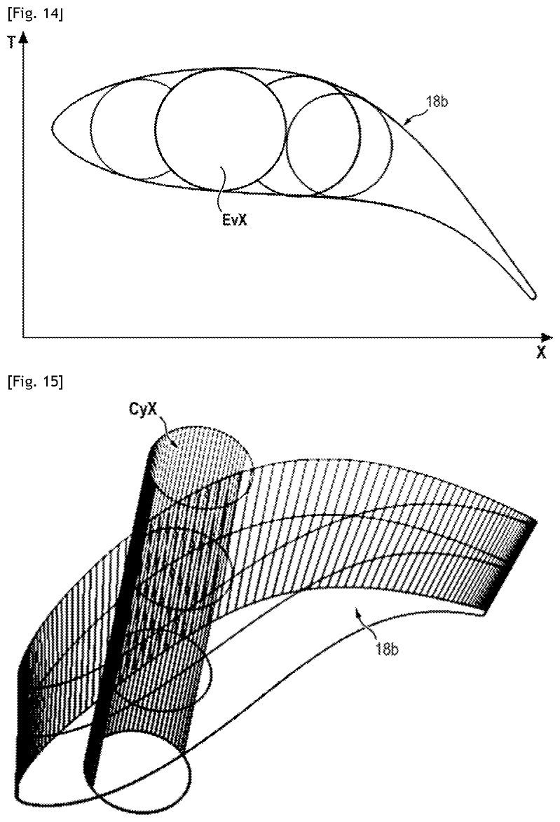

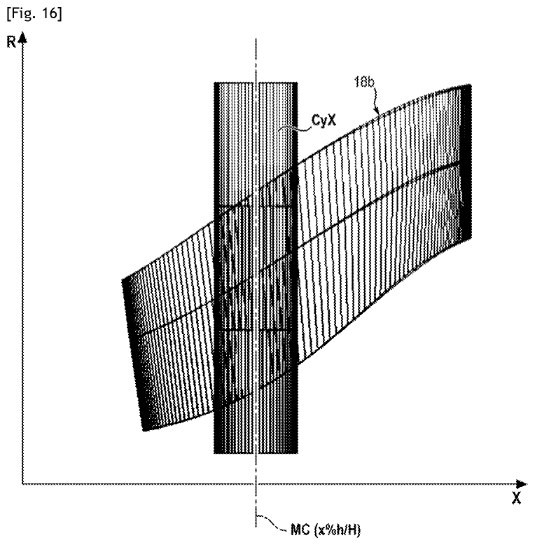

Then, the shell element Ev1, Ev2, Ev3, Ev4 with the largest surface allows locating the position of the master cross-section MC for a predefined h/H ratio. In FIGS. 14, 15 and 16, the shell element with the largest surface is noted EvX and belongs to the cylinder CyX. Once the shell element with the largest surface EvX has been identified (FIG. 14), and thus the identified corresponding cylinder CyX (FIG. 15), the generatrix of this cylinder (in dashed lines in FIG. 16) allows determining the position on the longitudinal axis X of the master cross-section MC for a predefined h/H ratio. Thus, the value of the master cross-section MC measured on a cross-sectional surface at X % of h/H, where X is equal to 10, 50 or 90, is the axial value of the generatrix of the cylinder CyX with the largest surface of its shell element EvX. The position of the master cross-section MC, on a section at X % of h/H, is visible in FIG. 16.

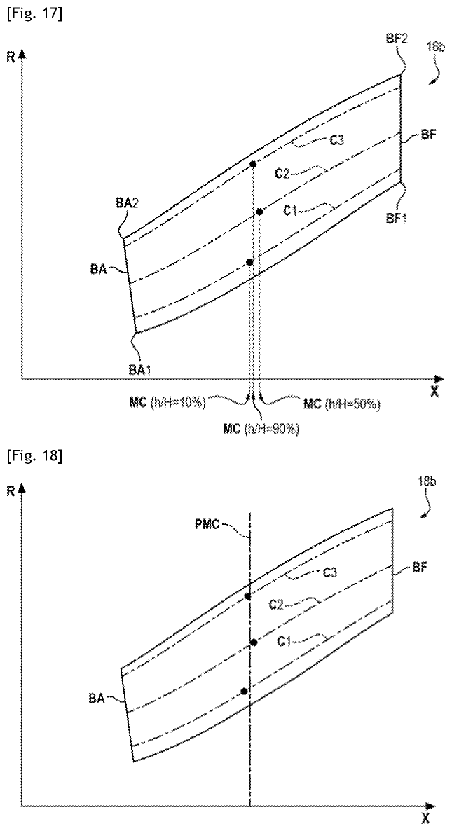

The second step of estimating the mean position of the master cross-sections MC over the height giving the position of the plane PMC is then described with reference to FIGS. 17 and 18. Thus, the position of the master cross-section MC for the three cross-sectional surfaces C1, C2, C3 can be plotted on these cross-sectional surfaces C1, C2, C3, as visible in FIG. 17, with the positions of the master cross-section MC at h/H=10%, h/H=50% and h/H=90%. This is FIG. 9 with the plotted MC positions previously obtained during the first step.

Once the positions of the master cross-section MC at 10%, 50% and 90% of h/H are available, the position of the plane PMC passing through the master cross-section PMC, normal to the longitudinal axis X, is obtained by the mean position, the arithmetic mean, between the three positions estimated previously, as visible by the dashed line in FIG. 18 representing the plane PMC. The position of this plane PMC can vary around the mean position represented in FIG. 18 within a range of ±2.5%, as previously indicated.

With the aim of being able to reduce the pressure drops, as explained previously, the invention proposes to open the aerodynamic flowpath section, as represented by dashed lines in FIG. 5, at the level of the master cross-section MC of the thick arms 18b. This flowpath opening logic is based on the assumption that it is necessary to deal with the flowpath obstruction, represented by the obstructed section Sₒ in FIG. 6, generated by the thick arms 18b through a section opening by modification of the outer VRp2 and inner VRp1 walls, as visible in FIG. 5.

Also, it is necessary to determine the new radius Rₑ₂ of the outer wall VRp2 and the new radius Rᵢ₂ of the inner wall VRp1 that allow opening the aerodynamic flowpath section to recover the section obstructed Sₒ by the thick arm 18b (see FIG. 5).

The reference flowpath section VR is defined by the reference radius R_{eRef} of the outer wall VRp2 and the reference radius R_{iRef} of the inner wall VRp1 on the plane PMC, as visible in FIG. 5.

The obstructed section Sₒ is approximated by a function of the master cross-section MC of the thick arms 18b, the number Nb of thick arms 18b, and the reference radii R_{eRef} and R_{iRef}, namely:

SₒSₒ=MC(R_{eRef}−R_{iRef})N_{b}

The required excess section is modeled by means of an inner circular ring ΔSᵢ and an outer circular ring ΔSₑ at the reference flowpath VR, as visible in FIG. 6, the sum of the two allows recovering the obstructed section Sₒ. The distribution of the obstructed section Sₒ on the inner VRp1 and outer VRp2 walls is managed by a factor X that varies between 0 corresponding to the entire section recovered via an inner circular ring ΔSᵢ at the reference flowpath VR, and 1 corresponding to the entire section recovered via an outer circular ring ΔSₑ at the reference flowpath VR.

The following equations are obtained:

ΔSₒΔSₑ+ΔSᵢ=χSₒ+(1−χ)Sₒ

and:

ΔSₑ=χSₒ

and:

ΔSᵢ=(1−χ)Sₒ

The two circular rings ΔSᵢ and ΔSₑ must also take into account the obstruction of the thick arms 18b which will necessarily remain inside them, which allows stating the following equations:

$$Δ {S}_{e} = π ( {R}_{e 2}^{2} - {R}_{eRef}^{2} ) - MC ( {R}_{e 2} - {R}_{eRef} ) {N}_{b} = χ {S}_{o}$$

$$Δ {S}_{i} = π ( {R}_{iRef}^{2} - {R}_{i 2}^{2} ) - MC ( {R}_{iRef} - {R}_{i 2} ) {N}_{b} = ( 1 - χ ) {S}_{o}$$

These two previous formulations can be rearranged into the format of a second-order equation to isolate the unknowns Rₑ₂ and Rᵢ₂. the following equations are then obtained:

$${a}_{e} {R}_{e 2}^{2} + {b}_{e} {R}_{e 2} + {c}_{e} = 0$$

$${a}_{i} {R}_{i 2}^{2} + {b}_{i} {R}_{i 2} + {c}_{i} = 0$$

aₑ, aᵢ are a coefficient on the second-order term of the equation giving Rₑ₂, Rᵢ₂. Similarly, bₑ, bᵢ are a coefficient on the first-order term of the equation giving Rₑ₂, Rᵢ₂. Finally, cₑ, cᵢ are a coefficient on the zero-order term of the equation giving Rₑ₂, Rᵢ₂.

It is then possible to estimate the parameters Rₑ₂ and Rᵢ₂ using the following equations:

$${R}_{e 2} = {R}_{e 2}^{′} \times \frac{1}{ε} = \frac{- {b}_{e} + \sqrt{{Δ}_{e}}}{2 {a}_{e}} \frac{1}{ε}$$

$${R}_{i 2} = {R}_{i 2}^{′} \times ε = \frac{- {b}_{i} + \sqrt{{Δ}_{i}}}{2 {a}_{i}} ε$$

where:

$${R}_{e 2}^{′}$$

is a calculated outer opening radius,

$${R}_{i 2}^{′}$$

is a calculated inner opening radius,
and:

$${Δ}_{e} = {b}_{e}^{2} - 4 {a}_{e} {c}_{e}$$

and:

$${Δ}_{i} = {b}_{i}^{2} - 4 {a}_{i} {c}_{i}$$

In order to estimate the value of Rₑ₂, it is possible to use the following values of the parameters:

$${a}_{e} = 1$$

$${b}_{e} = - \frac{MC}{π} {N}_{b}$$

$${c}_{e} = - ( \frac{χ {S}_{o}}{π} - \frac{MC}{π} {N}_{b} {R}_{eRef} + {R}_{eRef}^{2} )$$

Similarly, in order to be able to estimate the value of Rᵢ₂, it is possible to use the following values of the parameters:

$${a}_{i} = 1$$

$${b}_{i} = - \frac{MC}{π} {N}_{b}$$

$${c}_{i} = \frac{( 1 - χ ) {S}_{o}}{π} + \frac{MC}{π} {N}_{b} {R}_{iRef} - {R}_{iRef}^{2}$$

It should be noted that the parameter ε is based on an experience feedback and can vary between 1 and 1.04.

Furthermore, it should be noted that the chosen value of Rₑ₂ can be the one given by the previous formula at ±1%, namely:

$$0.99 \times {R}_{e 2}^{′} \times \frac{1}{ε} \leq {R}_{e 2} \leq 1.01 \times {R}_{e 2}^{′} \times \frac{1}{ε}$$

Similarly, it should be noted that the chosen value of Rᵢ₂ can be the one given by the previous formula at ±1%, namely:

$$0.99 \times {R}_{i 2}^{′} \times ε \leq {R}_{i 2} \leq 1.01 \times {R}_{i 2}^{′} \times ε$$

Thus, the new radii Rₑ₂ and Rᵢ₂ are a function of the parameters MC, Nb, R_{eRef}, R_{iRef}, χ, and ε, that is to say a function of the geometry of the reference flowpath VR, the geometry of the thick arms 18b, and the number of thick arms 18b.

Consequently, any section opening corresponding to radii Rₑ₂ and Rᵢ₂ that can be estimated by the preceding equations, with the parameters χ and ε varying respectively in the ranges from 0 to 1 and 1 to 1.04, or corresponding to radii at ±1% of the calculated values, will then allow reducing the pressure drops with a section opening defined according to the preceding equations.

Specifically, the casing 18 has an aerodynamic flowpath opening OV at the level of the thick arm 18b defined by the presence, by observation in axial section of the thick arm 18b at the level of the plane PMC passing through the master cross-section MC of the arm 18b, perpendicular to the longitudinal axis X, of a spacing between the straight line VRp1 joining the first inner point BA1 and the second inner point BF1 and the junction between the inner shroud 18i and the radially inner end of the thick arm 18b, and a spacing between the straight line VRp2 joining the first outer point BA2 and the second outer point BF2 and the junction between the outer shroud 18e and the radially outer end of the thick arm 18b, as visible in FIG. 5.

This aerodynamic flowpath opening OV has, by observation in tangential section of the thick arm 18b at the level of the plane PMC, an inner circular ring ΔSᵢ and an outer circular ring ΔSₑ representing the excess section related to the aerodynamic flowpath opening OV relative to the section obstructed Sₒ by the thick arm 18b,
the outer circular ring ΔSₑ being defined as:

$$Δ {S}_{e} = π ( {R}_{e 2}^{2} - {R}_{eRef}^{2} ) - MC ( {R}_{e 2} - {R}_{eRef} ) {N}_{b} = χ {S}_{o}$$

with:

Sₒ=MC(R_{eRef}−R_{iRef})N_{b}
where:
MC is the master cross-section, or maximum thickness, of the thick arm 18b,
Nb is the number of thick arms 18b of the casing 18,
χ is a distribution factor of the obstructed section Sₒ,

Advantageously, the parameter ΔSₑ is chosen such that ΔSₑ is strictly greater than 0% and strictly less than 100% of the obstructed section Sₒ, and:
R_{eRef} is chosen such that 0.21 m≤R_{eRef}≤0.30 m,
R_{iRef} is chosen such that 0.14 m≤R_{iRef}≤0.23 m,
MC is chosen such that 0.018≤m≤MC≤0.035 m,
Nb is chosen such that 8≤Nb≤24,
Sₒ is chosen such that 0.01 m²≤Sₒ≤0.10 m²,
χ is chosen such that 0≤χ≤1.

Furthermore, the parameter ΔSₑ is preferentially chosen such that ΔSₑ is is comprised between 40% and 60% of the obstructed section Sₒ.

It should be noted that the more the master cross-section MC and the number of arms Nb increase, the more outer circular ring ΔSₑ grows to meet the need to open the aerodynamic flowpath. The more the parameter χ increases, the more the value of the outer circular ring ΔSₑ increases.

Moreover, the inner circular ring ΔSᵢ is defined as:

$$Δ {S}_{i} = π ( {R}_{iRef}^{2} - {R}_{i 2}^{2} ) - MC ( {R}_{iRef} - {R}_{i 2} ) {N}_{b} = ( 1 - χ ) {S}_{o}$$

Advantageously, the parameter ΔSᵢ is chosen such that ΔSᵢ is strictly greater than 0% and strictly less than 100% of the obstructed section Sₒ.

Furthermore, the parameter ΔSᵢ is preferably chosen such that ΔSᵢ is comprised between 40% and 60% of the obstructed section Sₒ.

It should be noted that the more the master cross-section MC and the number of arms Nb increase, the more the inner circular ring ΔSᵢ grows to meet the need to open the aerodynamic flowpath. The more the parameter χ increases, the more the value of the inner circular ring ΔSᵢ decreases.
in addition, a calculated outer opening radius

$${R}_{e 2}^{′}$$

is defined as:

$${R}_{e 2}^{′} = \frac{- {b}_{e} + \sqrt{{Δ}_{e}}}{2 {a}_{e}}$$

with:

$${Δ}_{e} = {b}_{e}^{2} - 4 {a}_{e} {c}_{e}$$

and:

$${b}_{e} = - \frac{MC}{π} {N}_{b}$$

and:

$${c}_{e} = - ( \frac{χ {S}_{o}}{π} - \frac{MC}{π} {N}_{b} {R}_{eRef} + {R}_{eRef}^{2} )$$

where:
aₑ is chosen such that aₑ=1.

The outer opening radius Rₑ₂ can be chosen such that

$${R}_{eRef} < {R}_{e 2} \leq {R}_{e 2}^{′} .$$

The outer opening radius Rₑ₂ can be chosen such that:

$${R}_{e 2} = {R}_{e 2}^{′} \times \frac{1}{ε}$$

The outer opening radius Rₑ₂ can be chosen such that:

$$0.99 \times {R}_{e 2}^{′} \times \frac{1}{ε} \leq {R}_{e 2} \leq 1.01 \times {R}_{e 2}^{′} \times \frac{1}{ε}$$

where:
ε is a resetting factor of the radius Rₑ₂ chosen such that 1≤ε≤1.04.

Moreover, a calculated inner opening radius

$${R}_{i 2}^{′}$$

is defined as:

$${R}_{i 2}^{′} = \frac{- {b}_{i} + \sqrt{{Δ}_{i}}}{2 {a}_{i}}$$

with:

$${Δ}_{i} = {b}_{i}^{2} - 4 {a}_{i} {c}_{i}$$

and:

$${b}_{i} = - \frac{MC}{π} {N}_{b}$$

and:

$${c}_{i} = \frac{( 1 - χ ) {S}_{o}}{π} + \frac{MC}{π} {N}_{b} {R}_{iRef} - {R}_{iRef}^{2}$$

and the method includes a step of dimensioning the casing 18 during which: aᵢ is chosen such that aᵢ=1.

The inner opening radius Rᵢ₂ can be chosen such that

$${R}_{i 2}^{′} \leq {R}_{i 2} < {R}_{iRef} .$$

The inner opening radius Rᵢ₂ can be chosen such that:

$${R}_{i 2} = {R}_{i 2}^{′} \times ε$$

The inner opening radius Rᵢ₂ can be chosen so that:

$$0.99 \times {R}_{i 2}^{′} \times ε \leq {R}_{i 2} \leq 1.01 \times {R}_{i 2}^{′} \times ε$$

where:
ε is a resetting factor of the radius Rᵢ₂ chosen such that 1≤ε≤1.04.

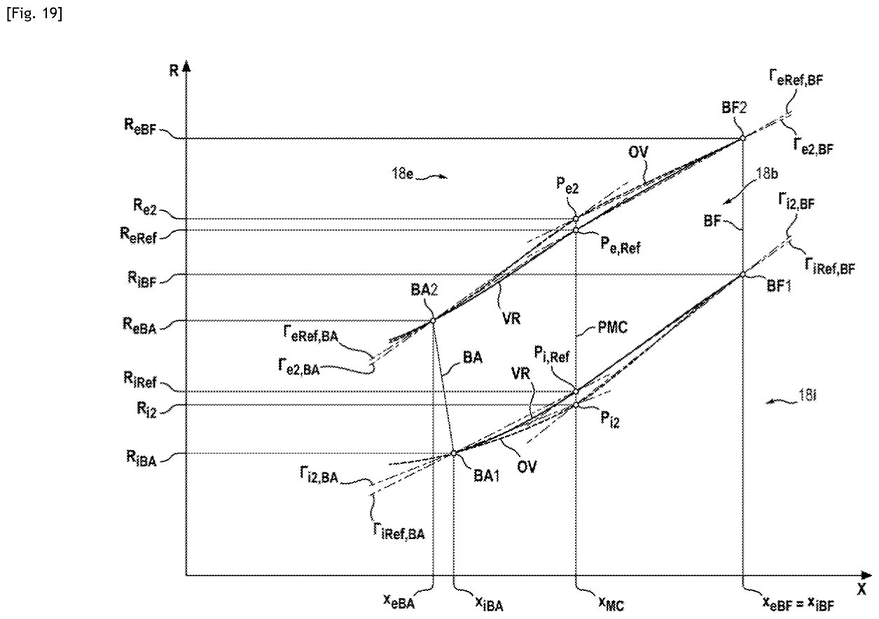

FIG. 19 is a view similar to that of FIG. 5, and allows visualizing the tangents or slopes Γ_{i2,BA}, Γ_{e2,BA}, Γ_{2,BF} and Γ_{e2,BF} at the level of the corner points BA1, BA2, BF1 and BF2, namely at the level of the upstream and downstream aerodynamic flowpaths, on the inner side and on the outer side.

Thus, a calculated leading edge inner flowpath tangent

$${Γ}_{i 2 , BA}^{′}$$

defined as:

$${Γ}_{i 2 , BA}^{′} = {Γ}_{iRef , BA} - \vert \frac{{R}_{i 2} - {R}_{iRef}}{{x}_{MC} - {x}_{i , BA}} \vert$$

with:

$${Γ}_{iRef , BA} = \frac{{R}_{iRef} - {R}_{i , BA}}{{x}_{MC} - {x}_{i , BA}}$$

where:
Γ_{iRef,BA} is the leading edge reference inner flowpath tangent, passing through the first inner inflection point BA1 of the leading edge BA of the structural arm 18b and through the reference inner opening point P_{iRef} located at the reference inner radius
R_{iRef} along the radial axis R and at the mean position x_{MC} of the master cross-section MC along the longitudinal axis X,
R_{i,BA} is the radius along the radial axis R of the first inner inflection point BA1 of the leading edge BA of the structural arm 18b,
x_{i,BA} is the position along the longitudinal axis X of the first inner inflection point BA1 of the leading edge BA of the structural arm 18b.

The leading edge iner flowpath tangent Γ_{i2,BA}, passing through the first inner inflection point BA1 of the leading edge BA of the structural arm 18b and through the inner opening point Pᵢ₂, located at the inner opening radius Rᵢ₂ and at the mean position x_{MC} of the master cross-section MC along the longitudinal axis X, is chosen such that:

$$0.95 \times {Γ}_{i 2 , BA}^{′} \leq {Γ}_{i 2 , BA} < {Γ}_{iRef , BA}$$

Moreover, a calculated leading edge outer flowpath tangent

$${Γ}_{e 2 , BA}^{′}$$

is defined as:

$${Γ}_{e 2 , BA}^{′} = {Γ}_{eRef , BA} + \vert \frac{{R}_{e 2} - {R}_{eRef}}{{x}_{MC} - {x}_{e , BA}} \vert$$

with:

$${Γ}_{eRef , BA} = \frac{{R}_{eRef} - {R}_{e , BA}}{{x}_{MC} - {x}_{e , BA}}$$

where:
Γ_{eRef,BA} is the leading edge reference outer flowpath tangent, passing through the first outer inflection point BA2 of the leading edge BA of the structural arm 18b and through the reference outer opening point P_{eRef}, located at the reference outer radius R_{eRef} along the radial axis R and at the mean position x_{MC} of the master cross-section MC along the longitudinal axis X,
R_{e,BA} is the radius along the radial axis R of the first outer inflection point BA2 of the leading edge BA of the structural arm 18b,
x_{e,BA} is the position along the longitudinal axis X of the first outer inflection point BA2 of the leading edge BA of structural arm 18b.

The leading edge outer flowpath tangent Γ_{e2,BA} passing through the first outer inflection point BA2 of the leading edge BA of the structural arm 18b and through the outer opening point Pₑ₂, located at the outer opening radius Rₑ₂ and at the mean position x_{MC} of the master cross-section MC along the longitudinal axis X, is chosen such that:

$${Γ}_{eRef , BA} < {Γ}_{e 2 , BA} \leq 1.05 \times {Γ}_{e 2 , BA}^{′}$$

Furthermore, a calculated trailing edge inner flowpath tangent

$${Γ}_{i 2 , BF}^{′}$$

is defined as:

$${Γ}_{i 2 , BF}^{′} = {Γ}_{iRef , BF} + \vert \frac{{R}_{i 2} - {R}_{iRef}}{{x}_{MC} - {x}_{i , BF}} \vert$$

with:

$${Γ}_{iRef , BF} = \frac{{R}_{iRef} - {R}_{i , BF}}{{x}_{MC} - {x}_{i , BF}}$$

where:
Γ_{iRef,BF} is the trailing edge reference inner flowpath tangent, passing through the second inner inflection point BF1 of the trailing edge BF of the structural arm 18b and through the reference inner opening point P_{iRef}, located at the reference inner radius R_{iRef} along the radial axis R and at the mean position x_{MC} of the master cross-section MC along the longitudinal axis X,
R_{i,BF} is the radius along the radial axis R of the second inner inflection point BF1 of the trailing edge BF of the structural arm 18b,
x_{i,BF} is the position along the longitudinal axis X of the second inner inflection point BF1 of the trailing edge BF of the structural arm 18b.

The trailing edge inner flowpath tangent Γ_{i2,BF}, passing through the second inner inflection point BF1 of the trailing edge BF of the structural arm 18b and through the inner opening point Pᵢ₂, located at the inner opening radius Rᵢ₂ and at the mean position x_{MC} of the master cross-section MC along the longitudinal axis X, is chosen such that:

$${Γ}_{iRef , BF} < {Γ}_{i 2 , BF} \leq 1.05 \times {Γ}_{i 2 , BF}^{′}$$

In addition, a calculated trailing edge outer flowpath tangent

$${Γ}_{e 2 , BF}^{′}$$

is defined as:

$${Γ}_{e 2 , BF}^{′} = {Γ}_{eRef , BF} - \vert \frac{{R}_{e 2} - {R}_{eRef}}{{x}_{MC} - {x}_{e , BF}} \vert$$

with:

$${Γ}_{eRef , BF} = \frac{{R}_{eRef} - {R}_{e , BF}}{{x}_{MC} - {x}_{e , BF}}$$

where:
Γ_{eRef,BF} is the trailing edge reference outer flowpath tangent, passing through the second outer inflection point BF2 of the trailing edge BF of the structural arm 18b and through the reference outer opening point P_{eRef}, located at the reference outer radius R_{eRef} along the radial axis R and at the mean position x_{MC} of the master cross-section MC along the longitudinal axis X,
R_{e,BF} is the radius along the radial axis R of the second outer inflection point BF2 of the trailing edge BF of the structural arm 18b,
x_{e,BF} is the position along the longitudinal axis X of the second outer inflection point BF2 of the trailing edge BF of the structural arm 18b.

The trailing edge outer flowpath tangent Γ_{e2,BF}, passing through the second outer inflection point BF2 of the trailing edge BF of the structural arm 18b and through the outer opening point Pₑ₂, located at the outer opening radius Rₑ₂ and at the mean position x_{MC} of the master cross-section MC along the longitudinal axis X, is chosen such that:

$$0.95 \times {Γ}_{e 2 , BF}^{′} \leq {Γ}_{e 2 , BF} < {Γ}_{eRef , BF}$$

### Example

By setting the numerical values of some parameters described above, it may be possible to determine values for the radii Rₑ₂ and Rᵢ₂ allowing defining an optimal flowpath section opening which allows obtaining a reduction in the pressure drops and thus improving the efficiency of the inter-turbine casing 18 and therefore of the propulsion system 1.

The parameters MC, Nb, R_{eRef}, R_{iRef},X, and ε are set as follows:

MC=0.025 m

Nb=14

R_{eRef}=0.260 m

R_{iRef}=0.220m

χ=0.5

ε=1.017
the following is then obtained by substitution in the previous equations:

$${S}_{o} = MC ( {R}_{eRef} - {R}_{iRef} ) {N}_{b} = 0.025 ( 0.260 - 0.220 ) 14 = 0.014$$

$$Δ {S}_{e} = π ( {R}_{e 2}^{2} - {R}_{eRef}^{2} ) - MC ( {R}_{e 2} - {R}_{eRef} ) {N}_{b} = χ {S}_{o}$$

$$Δ {S}_{e} = π ( {R}_{e 2}^{2} - 0.26 {0}^{2} ) - 0.025 ( {R}_{e 2} - 0.260 ) 14 = 0.5 ( 0.014 ) = 0.007$$

$${a}_{e} = 1$$

$${b}_{e} = - \frac{MC}{π} {N}_{b} = - \frac{0.025}{π} 14 = - 0.111408$$

$$\begin{matrix}{c}_{e} = - ( \frac{χ {S}_{o}}{π} - \frac{MC}{π} {N}_{b} {R}_{eRef} + {R}_{eRef}^{2} ) \\ = - ( \frac{0.5 \times 0.014}{π} - \frac{0.025}{π} 14 \times 0.260 + 0.26 {0}^{2} ) \\ = - 0. 40862\end{matrix}$$

$${Δ}_{e} = {b}_{e}^{2} - 4 {a}_{e} {c}_{e} = {( - 0.111408 )}^{2} - 4 \times 1 \times ( - 0.040862 ) = 0.17586$$

$${R}_{e 2} = \frac{- {b}_{e} + \sqrt{{Δ}_{e}}}{2 {a}_{e}} \frac{1}{ε} = \frac{0.111408 + \sqrt{0.17586}}{2} \frac{1}{1.017} = 0.261$$

Ultimately, a value of Rₑ₂=0.261 m is therefore obtained.

The optimal value according to the invention is to be considered at ±1% of the calculated value, therefore it is considered that 0.258 m≤Rₑ₂ 0.264 m.

Moreover, the following equations are obtained:

$$Δ {S}_{i} = π ( {R}_{iRef}^{2} - {R}_{i 2}^{2} ) - MC ( {R}_{iRef} - {R}_{i 2} ) {N}_{b} = ( 1 - χ ) {S}_{o}$$

$$Δ {S}_{e} = π ( 0.22 {0}^{2} - {R}_{i 2}^{2} ) - ( 0.220 - {R}_{i 2} ) 14 = ( 1 - 0.5 ) 0.014 = 0.007$$

$${a}_{i} = 1$$

$${b}_{i} = - \frac{MC}{π} {N}_{b} = - \frac{0.025}{π} 14 = - 0.111408$$

$$\begin{matrix}{c}_{i} = \frac{( 1 - χ ) {S}_{o}}{π} + \frac{MC}{π} {N}_{b} {R}_{iRef} - {R}_{iRef}^{2} \\ = \frac{( 1 - 0.5 ) 0.014}{π} + \frac{0.025}{π} 14 \times 0.220 - 0.22 {0}^{2} \\ = - 0. 21662\end{matrix}$$

$${Δ}_{i} = {b}_{i}^{2} - 4 {a}_{i} {c}_{i} = {( - 0.111408 )}^{2} - 4 \times 1 \times ( - 0.021662 ) = 0.09906$$

$${R}_{i 2} = \frac{- {b}_{i} + \sqrt{{Δ}_{i}}}{2 {a}_{i}} ε = \frac{0.111408 + \sqrt{0.09906}}{2} 1.017 = 0.217$$

In conclusion, a value of Rᵢ₂=0.217 m is therefore obtained.

The optimal value according to the invention is to be considered at ±1% of the calculated value, it is therefore considered that 0.215 m≤Rᵢ₂ 0.219 m.

Moreover, by setting the numerical values of other parameters described previously, it may be possible to determine values for the tangents or slopes Γ_{i2,BA}, Γ_{e2,BA},Γ_{2,BF} and Γ_{e2,BF} at the level of the corner points, BA1, BA2, BF1 and BF2, allowing defining an optimal flowpath section opening which allows obtaining a reduction in the pressure drops and thus improving the efficiency of the inter-turbine casing 18 and therefore of the propulsion system 1.

Some of the parameters are set as follows:

MC=0.025 m

N_{b}=14

R_{eRef}=0.289

R_{iRef}=0.233 m

χ=0.5

ε=1.017

R_{i,BA}=0.198 m

R_{i,BF}=0.269 m

R_{e,BA}=0.251 m

R_{e,BF}=0.324 m

X_{i,BA}=0.054 m

X_{i,BF}=0.169 m

X_{e,BA}=0.046 m

x_{e,BF}=0.169 m

x_{MC}=0.11 m

By applying the equations stated above, the values of R_{eRef} and of R_{eRef} can then be calculated, namely:

Rₑ₂=0.291 m,

and Rᵢ₂=0.228 m.

Furthermore, by substitution in the previous equations stated for the tangents, the following is obtained:

$$1 / {Γ}_{i 2 , BA}^{′} = {Γ}_{iRef , BA} - \vert \frac{{R}_{i 2} - {R}_{iRef}}{{x}_{MC} - {x}_{i , BA}} \vert = \frac{{R}_{iRef} - {R}_{i , BA}}{{x}_{MC} - {x}_{i , BA}} - \vert \frac{{R}_{i 2} - {R}_{iRef}}{{x}_{MC} - {x}_{i , BA}} \vert = \frac{0.233 - 0.198}{0.11 - 0.054} - \vert \frac{0.228 - 0233}{0.11 - 0.054} \vert = 0.536$$

and thus:

$$0.95 \times {Γ}_{i 2 , BA}^{′} = 0.509 \leq {Γ}_{i 2 , BA} < {Γ}_{iRef , BA} = 0.625$$

$$2 / {Γ}_{e 2 , BA}^{′} = {Γ}_{eRef , BA} + \vert \frac{{R}_{e 2} - {R}_{eRef}}{{x}_{MC} - {x}_{e , BA}} \vert = \frac{{R}_{e Ref} - {R}_{e , BA}}{{x}_{MC} - {x}_{e , BA}} + \vert \frac{{R}_{e 2} - {R}_{eRef}}{{x}_{MC} - {x}_{e , BA}} \vert = \frac{0.289 - 0.251}{0.11 - 0.046} + \vert \frac{0.291 - 0.289}{0.11 - 0.046} \vert = 0.625$$

and thus:

$${Γ}_{eRef , BA} = 0.594 < {Γ}_{e 2 , BA} \leq 1.05 \times {Γ}_{e 2 , BA}^{′} = 0.656$$

$$3 / {Γ}_{i 2 , BF}^{′} = {Γ}_{iRef , BF} + \vert \frac{{R}_{i 2} - {R}_{iRef}}{{x}_{MC} - {x}_{i , BF}} \vert = \frac{{R}_{i Ref} - {R}_{i , BF}}{{x}_{MC} - {x}_{i , BF}} + \vert \frac{{R}_{i 2} - {R}_{iRef}}{{x}_{MC} - {x}_{i , BF}} \vert = \frac{0.233 - 0.269}{0.11 - 0.169} + \vert \frac{0.228 - 0.233}{0.11 - 0.169} \vert = 0.695$$

and thus:

$${Γ}_{iRef , BF} = 0.61 < {Γ}_{i 2 , BF} \leq 1.05 \times {Γ}_{i 2 , BF}^{′} = 0.73$$

$$4 / {Γ}_{e 2 , BF}^{′} = {Γ}_{eRef , BF} - \vert \frac{{R}_{e 2} - {R}_{eRef}}{{x}_{MC} - {x}_{e , BF}} \vert = \frac{{R}_{eRef} - {R}_{e , BF}}{{x}_{MC} - {x}_{e , BF}} - \vert \frac{{R}_{e 2} - {R}_{eRef}}{{x}_{MC} - {x}_{e , BF}} \vert = \frac{0.289 - 0.324}{0.11 - 0.169} - \vert \frac{0.291 - 0.289}{0.11 - 0.169} \vert = 0.559$$

and thus:

$$0.95 \times {Γ}_{e 2 , BF}^{′} = 0.531 \leq {Γ}_{e 2 , BF} < {Γ}_{eRef , BF} = 0.593$$

1. A turbomachine casing centered on a longitudinal axis, including an inner shroud and an outer shroud extending coaxially around the longitudinal axis, and structural arms connecting together the inner shroud and the outer shroud, the structural arms extending along a radial axis perpendicular to the longitudinal axis, each structural arm including a leading edge, a trailing edge, an intrados and an extrados, defining together the outer peripheral surface of the structural arm,
wherein the radially inner end of each structural arm is connected to the inner shroud and the radially outer end of each structural arm is connected to the outer shroud,
the radially inner end of each structural arm extending between a first inner inflection point of the leading edge of the structural arm located at the junction between the inner shroud and the leading edge of the structural arm band a second inner inflection point of the structural arm located at the junction between the inner shroud and the trailing edge of the structural arm, and the radially outer end of each structural arm extending between a first outer inflection point of the structural arm located at the junction between the outer shroud and the leading edge of the structural arm and a second outer inflection point of the structural arm located at the junction between the outer shroud and the trailing edge of the structural arm,
wherein each structural arm has a plane, normal to the longitudinal axis, passing through the master cross-section of the structural arm, whose position along the longitudinal axis is determined as follows:
generating at least one, preferably three, set(s) of cutting points defining together a cross-sectional surface of the structural arm, each set of cutting points being obtained by creating the intersection between the outer peripheral surface of each structural arm and a plurality of cutting planes normal to the longitudinal axis between the leading edge and the trailing edge of the structural arm, the cutting points being each taken radially at a constant flowpath height ratio h/H along the longitudinal axis, H being, in each cutting plane normal to the considered longitudinal axis, the radius difference between the outer shroud and the inner shroud and h being, in each cutting plane normal to the considered longitudinal axis, the radius difference between the height of the cutting point and the radius of the inner shroud, so as to obtain at least one cross-sectional surface with a constant flowpath height ratio, and preferably a first cross-sectional surface with a flowpath height ratio equal to 10%, a second cross-sectional surface with a flowpath height ratio equal to 50%, and a third cross-sectional surface with a flowpath height ratio equal to 90%, each intersection between the outer peripheral surface of each structural arm and one of the cutting planes normal to the longitudinal axis at a flowpath height ratio giving an intrados cutting point located on the intrados side of the structural arm and an extrados cutting point located on the extrados side of the structural arm,
then, for each cross-sectional surface, inscribing a plurality of cylinders inside the structural arm, each cylinder having a diameter and a generatrix perpendicular to the longitudinal axis and without intersection with the outer peripheral surface of the structural arm, the largest diameter allowing identifying the largest inscribable cylinder, which gives, through the axial position of its generatrix, the position along the longitudinal axis (X) of the master cross-section associated with the cross-sectional surface, and preferably at least three positions along the longitudinal axis of the master cross-section, each associated with a cross-sectional surface,
determining the arithmetic mean of the position(s) along the longitudinal axis of the master cross-section to obtain a mean position of the master cross-section along the longitudinal axis defining the master cross-section, the plane passing through the master cross-section being the plane perpendicular to the longitudinal axis and passing through the mean position of the master cross-section at ±2%,
wherein, by observation of each structural arm in a plane defined by the longitudinal axis and the radial axis, perpendicular to the plane passing through the master cross-section, the casing has an aerodynamic flowpath opening at the level of each structural arm defined:
by an aerodynamic flowpath inner opening which has an inner radial spacing formed between, on the one hand, the junction between the inner shroud and the radially inner end of the structural arm and, on the other hand, the straight line joining the first inner inflection point and the second inner inflection point, and/or
by an aerodynamic flowpath outer opening which has an outer radial spacing formed between, on the one hand, the junction between the outer shroud and the radially outer end of the structural arm and, on the other hand, the straight line joining the first outer inflection point and the second outer inflection point,
wherein the intersection between the straight line joining the first inner inflection point and the second inner inflection point, and the plane passing through the master cross-section of the structural arm, defines a reference inner radius R_{iRef} along the radial axis,
the intersection between the straight line joining the first outer inflection point and the second outer inflection point, and the plane passing through the master cross-section of the structural arm, defines a reference outer radius R_{eRef} along the radial axis,
the intersection between the junction of the inner shroud with the radially inner end of the structural arm forming the aerodynamic flowpath inner opening, and the plane passing through the master cross-section of the structural arm, defines an inner opening radius Rᵢ₂ along the radial axis,
the intersection between the junction of the outer shroud with the radially outer end of the structural arm forming the aerodynamic flowpath outer opening and the plane passing through the master cross-section of the structural arm, defines an outer opening radius Rₑ₂ along the radial axis,
wherein a calculated trailing edge outer flowpath tangent
$${Γ}_{e 2 , BF}^{′}$$
is defined as
$${Γ}_{e 2 , BF}^{′} = {Γ}_{eRef , BF} - \vert \frac{{R}_{e 2} - {R}_{eRef}}{{x}_{MC} - {x}_{e , BF}} \vert$$
with Γ_{eRef},
$$BF = \frac{{R}_{eRef} - {R}_{e , BF}}{{x}_{MC} - {x}_{e , BF}}$$
where:
Γ_{eRef,BF} is the trailing edge reference outer flowpath tangent, passing through the second outer inflection point of the trailing edge of the structural arm and through the reference outer opening point, located at the reference outer radius R_{eRef} along the radial axis and at the mean position of the master cross-section along the longitudinal axis,
R_{e, BF} is the radius along the radial axis of the second outer inflection point of the trailing edge of the structural arm,
x_{e, BF} is the position along the longitudinal axis of the second outer inflection point of the trailing edge of the structural arm,
and wherein the trailing edge outer flowpath tangent Γ_{e2, BF}, passing through the second outer inflection point of the trailing edge of the structural arm band through the outer opening point, located at the outer opening radius Rₑ₂ and at the mean position of the master cross-section along the longitudinal axis, is chosen such that 0.95×
$${Γ}_{e 2 , BF}^{′} \leq {Γ}_{e 2 , BF} < {Γ}_{eRef , BF} .$$

2. The casing according to claim 1, wherein a calculated outer opening radius
$${R}_{e 2}^{′}$$
is defined as
$${R}_{e 2}^{′} = \frac{- {b}_{e} + \sqrt{{Δ}_{e}}}{2 {a}_{e}}$$
with
$${Δ}_{e} = {b}_{e}^{2} - 4 {a}_{e} {c}_{e}$$
and
$${b}_{e} = - \frac{MC}{π} {N}_{b}$$
and
$${c}_{e} = - ( \frac{{χS}_{o}}{π} - \frac{MC}{π} {N}_{b} {R}_{eRef} + {R}_{eRef}^{2} )$$
and Sₒ=MC(R_{eRef}−R_{iRef})N_{b}
where:
MC is the master cross-section of the structural arm,
Nb is the number of structural arms of the casing,
χ is a distribution factor of the obstructed section Sₒ,
aₑ is a predefined coefficient,
wherein:
R_{eRef} is chosen such that 0.21 m≤R_{eRef}≤0.30 m,
R_{iRef} is chosen such that 0.14 m≤R_{iRef}≤0.23 m,
MC is chosen such that 0.018 m≤MC≤0.035 m,
Nb is chosen such that 8≤N_{b}≤24,
Sₒ is chosen such that 0.01 m²≤Sₒ≤0.10 m²
χ is chosen such that 0<χ<1,
aₑ is chosen such that aₑ=1.

3. The casing according to claim 2, wherein the outer opening radius Rₑ₂ is chosen such that
$${R}_{eRef} < {R}_{e 2} \leq {R}_{e 2}^{′} .$$

4. The casing according to claim 2, wherein the outer opening radius Rₑ₂ is chosen such that
$${R}_{e 2} = {R}_{e 2}^{′} \times \frac{1}{ε}$$
where:
ε is a resetting factor of the radius Rₑ₂ chosen such that 1≤ε≤1.04.

5. The casing according to claim 2, wherein the outer opening radius Rₑ₂ is chosen such that
$$0.99 \times {R}_{e 2}^{′} \times \frac{1}{ε} \leq {R}_{e 2} \leq 1.01 \times {R}_{e 2}^{′} \times \frac{1}{ε} .$$

6. The casing according to claim 1, wherein a calculated inner opening radius
$${R}_{i 2}^{′}$$
is defined as
$${R}_{i 2}^{′} = \frac{- {b}_{i} + \sqrt{{Δ}_{i}}}{2 {a}_{i}}$$
with
$${Δ}_{i} = {b}_{i}^{2} - 4 {a}_{i} {c}_{i}$$
and
$${b}_{i} = - \frac{MC}{π} {N}_{b}$$
and
$${c}_{i} = \frac{( 1 - χ ) {S}_{o}}{π} + \frac{MC}{π} {N}_{b} {R}_{iRef} - {R}_{iRef}^{2}$$
where:
aᵢ is a predefined coefficient,
wherein:
aᵢ is chosen such that aᵢ=1.

7. The casing according to claim 6, wherein the inner opening radius Rᵢ₂ is chosen such that
$${R}_{i 2}^{′} \leq {R}_{i 2} < {R}_{iRef} .$$

8. The casing according to claim 6, wherein the inner opening radius Rᵢ₂ is chosen such that
$${R}_{i 2} = {R}_{i 2}^{′} \times ε$$
where:
ε is a resetting factor of the radius Rᵢ₂ chosen such that 1≤ε≤1.04.

9. The casing according to claim 6, wherein the inner opening radius Rᵢ₂ is chosen such that
$$0.99 \times {R}_{i 2}^{′} \times ε \leq {R}_{i 2} \leq 1.01 \times {R}_{i 2}^{′} \times ε .$$

10. The casing according to any one of claim 1, wherein a calculated leading edge inner flowpath tangent
$${Γ}_{i 2 , BA}^{′}$$
is defined as
$${Γ}_{i 2 , BA}^{′} = {Γ}_{iRef , BA} - \vert \frac{{R}_{i 2} - {R}_{i , Ref}}{{x}_{MC} - {x}_{i , BA}} \vert$$
with
$${Γ}_{iRef , BA} = \frac{{R}_{iRef} - {R}_{i , BA}}{{x}_{MC} - {x}_{i , BA}}$$
where:
Γ_{iRef,BA} is the leading edge reference inner flowpath tangent, passing through the first inner inflection point of the leading edge of the structural arm and through the reference inner opening point, located at the reference inner radius R_{iRef} along the radial axis and at the mean position of the master cross-section along the longitudinal axis,
R_{i, BA} is the radius along the radial axis of the first inner inflection point of the leading edge of the structural arm,
x_{i, BA} is the position along the longitudinal axis of the first inner inflection point of the leading edge of the structural arm.

11. The casing according to claim 10, wherein the leading edge inner flowpath tangent Γ_{i2,BA}, passing through the first inner inflection point of the leading edge of the structural arm and through the inner opening point, located at the inner opening radius Rᵢ₂ and at the mean position of the master cross-section along the longitudinal axis, is chosen such that
$$0.95 \times {Γ}_{i 2 , BA}^{′} \leq {Γ}_{i 2 , BA} < {Γ}_{iRef , BA} .$$

12. The casing according to claim 1, wherein a calculated leading edge outer flowpath tangent
$${Γ}_{e 2 , BA}^{′}$$
is defined as
$${Γ}_{e 2 , B A}^{′} = {Γ}_{eRef , BA} + \vert \frac{{R}_{e 2} - {R}_{eRef}}{{x}_{MC} - {x}_{e , BA}} \vert$$
with
$${Γ}_{eRef , BA} = \frac{{R}_{eRef} - {R}_{e , BA}}{{x}_{MC} - {x}_{e , BA}}$$
where:
Γ_{eRef, BA} is the leading edge reference outer flowpath tangent, passing through the first outer inflection point of the leading edge of the structural arm and through the reference outer opening point, located at the reference outer radius R_{eRef} along the radial axis and at the mean position of the master cross-section along the longitudinal axis,
R_{e, BA} is the radius along the radial axis of the first outer inflection point of the leading edge of the structural arm,
x_{e, BA} is the position along the longitudinal axis of the first outer inflection point of the leading edge of the structural arm.

13. The casing according to claim 12, wherein the leading edge outer flowpath tangent Γ_{e2, BA}, passing through the first outer inflection point of the leading edge of the structural arm and through the outer opening point, located at the outer opening radius Rₑ₂ and at the mean position of the master cross-section along the longitudinal axis, is chosen such that
$${Γ}_{e Ref , BA} < {Γ}_{e 2 , BA} \leq 1.05 \times {Γ}_{e 2 , B A}^{′} .$$

14. The casing according to claim 1, wherein a calculated trailing edge inner flowpath tangent
$${Γ}_{i 2 , BF}^{′}$$
is defined as
$${Γ}_{i 2 , BF}^{′} = {Γ}_{i Ref , BF} + \vert \frac{{R}_{i 2} - {R}_{i R e f}}{{x}_{M C} - {x}_{i , BF}} \vert$$
with
$${Γ}_{i Ref , BF} = \frac{{R}_{i R e f} - {R}_{i , BF}}{{x}_{M C} - {x}_{i , BF}}$$
where:
Γ_{iRef, BF} is the trailing edge reference inner flowpath tangent, passing through the second inner inflection point of the trailing edge of the structural arm and through the reference inner opening point, located at the reference inner radius R_{iRef} along the radial axis and at the mean position of the master cross-section along the longitudinal axis,
R_{i, BF} is the radius along the radial axis of the second inner inflection point of the trailing edge of the structural arm,
x_{i, BF} is the position along the longitudinal axis-of the second inner inflection point of the trailing edge of the structural arm.

15. The casing according to claim 14, wherein the trailing edge inner flowpath tangent Γ_{i2, BF}, passing through the second inner inflection point of the trailing edge of the structural arm band through the inner opening point, located at the inner opening radius Rᵢ₂ and at the mean position of the master cross-section along the longitudinal axis, is chosen such that
$${Γ}_{i Ref , BF} < {Γ}_{i 2 , BF} \leq 1.05 \times {Γ}_{i 2 , B F}^{′} .$$

16. The casing according to claim 1, wherein the aerodynamic flowpath outer opening has, by sectional observation in a plane defined by the tangential axis and the radial axis at the level of the plane passing through the master cross-section of the structural arm, an outer circular ring representing the excess section related to the aerodynamic flowpath outer opening relative to the section obstructed by the structural arm,
the outer circular ring being defined as
$$Δ {S}_{e} = π ( {R}_{e 2}^{2} - {R}_{eRef}^{2} ) - M C ( {R}_{e 2} - {R}_{eRef} ) {N}_{b} = χ {S}_{o}$$
wherein the parameter ΔSₑ is chosen such that ΔSₑ is strictly greater than 0% and strictly less than 100% of the obstructed section Sₒ.

17. The casing according to claim 16, wherein the parameter ΔSₑ is chosen such that ΔSₑ is comprised between 40% and 60% of the obstructed section Sₒ.

18. The casing according to claim 1, wherein the aerodynamic flowpath inner opening has, by sectional observation in a plane defined by the tangential axis and the radial axis at the level of the plane passing through the master cross-section of the structural arm, an inner circular ring representing the excess section related to the aerodynamic flowpath inner opening relative to the section obstructed by the structural arm,
the inner circular ring being defined as
$$Δ {S}_{i} = π ( {R}_{iRef}^{2} - {R}_{i 2}^{2} ) - M C ( {R}_{iRef} - {R}_{i 2} ) {N}_{b} = ( 1 - χ ) {S}_{o}$$
wherein the parameter ΔSᵢ is chosen such that ΔSᵢ is strictly greater than 0% and strictly less than 100% of the obstructed section Sₒ.

19. The casing according to claim 18, wherein the parameter ΔSᵢ is chosen such that ΔSᵢ is comprised between 40% and 60% of the obstructed section Sₒ.

20. The casing according to claim 1, wherein the casing is an inter-turbine casing intended to be positioned between a low-pressure turbine and a high-pressure turbine.

21. A turbomachine including a casing according to any one of claim 1.

22. A method for manufacturing a turbomachine casing centered on a longitudinal axis, including an inner shroud and an outer shroud extending coaxially around the longitudinal axis, and structural arms connecting together the inner shroud and the outer shroud, the structural arms extending along a radial axis perpendicular to the longitudinal axis, each structural arm including a leading edge, a trailing edge, an intrados and an extrados, defining together the outer peripheral surface of the structural arm,
wherein the radially inner end of each structural arm is connected to the inner shroud and the radially outer end of each structural arm is connected to the outer shroud,
the radially inner end of each structural arm extending between a first inner inflection point of the leading edge of the structural arm located at the junction between the inner shroud and the leading edge of the structural arm and a second inner inflection point of the structural arm located at the junction between the inner shroud and the trailing edge of the structural arm, and the radially outer end of each structural arm extending between a first outer inflection point of the structural arm located at the junction between the outer shroud and the leading edge of the structural arm and a second outer inflection point of the structural arm located at the junction between the outer shroud and the trailing edge of the structural arm,
wherein each structural arm has a plane, normal to the longitudinal axis, passing through the master cross-section of the structural arm, whose position along the longitudinal axis is determined as follows:
generating at least one, preferably three, set(s) of cutting points defining together a cross-sectional surface of the structural arm, each set of cutting points being obtained by creating the intersection between the outer peripheral surface of each structural arm and a plurality of cutting planes normal to the longitudinal axis between the leading edge and the trailing edge of the structural arm, the cutting points being each taken radially at a constant flowpath height ratio h/H along the longitudinal axis, H being, in each cutting plane normal to the considered longitudinal axis, the radius difference between the outer shroud and the inner shroud and h being, in each cutting plane normal to the considered longitudinal axis, the radius difference between the height of the cutting point and the radius of the inner shroud, so as to obtain at least one cross-sectional surface with a constant flowpath height ratio, and preferably a first cross-sectional surface with a flowpath height ratio equal to 10%, a second cross-sectional surface with a flowpath height ratio equal to 50% and a third cross-sectional surface with a flowpath height ratio equal to 90%, each intersection between the outer peripheral surface of each structural arm and one of the cutting planes normal to the longitudinal axis at a flowpath height ratio giving an intrados cutting point located on the intrados side of the structural arm and an extrados cutting point located on the extrados side of the structural arm,
then, for each cross-sectional surface, inscribing a plurality of cylinders inside the structural arm, each cylinder having a diameter and a generatrix perpendicular to the longitudinal axis and without intersection with the outer peripheral surface of the structural arm, the largest diameter allowing identifying the largest inscribable cylinder which gives, through the axial position of its generatrix, the position along the longitudinal axis of the master cross-section associated with the cross-sectional surface, and preferably at least three positions along the longitudinal axis of the master cross-section each associated with a cross-sectional surface,
determining the arithmetic mean of the position(s) along the longitudinal axis of the master cross-section to obtain a mean position of the master cross-section along the longitudinal axis defining the master cross-section, the plane passing through the master cross-section being the plane perpendicular to the longitudinal axis and passing through the mean position of the master cross-section at ±2%,
wherein, by observation of each structural arm in a plane defined by the longitudinal axis and the radial axis, perpendicular to the plane passing through the master cross-section, the casing has an aerodynamic flowpath opening at the level of each structural arm defined:
by an aerodynamic flowpath inner opening which has an inner radial spacing formed between, on the one hand, the junction between the inner shroud and the radially inner end of the structural arm and, on the other hand, the straight line joining the first inner inflection point and the second inner inflection point, and/or
by an aerodynamic flowpath outer opening which has an outer radial spacing formed between, on the one hand, the junction between the outer shroud and the radially outer end of the structural arm and, on the other hand, the straight line joining the first outer inflection point and the second outer inflection point,
wherein the intersection between the straight line joining the first inner inflection point and the second inner inflection point, and the plane passing through the master cross-section of the structural arm, defines a reference inner radius R_{iRef} along the radial axis,
the intersection between the straight line joining the first outer inflection point and the second outer inflection point, and the plane passing through the master cross-section of the structural arm, defines a reference outer radius R_{eRef} along the radial axis,
the intersection between the junction of the inner shroud (18i) with the radially inner end of the structural arm forming the aerodynamic flowpath inner opening, and the plane passing through the master cross-section of the structural arm, defines an inner opening radius Rᵢ₂ along the radial axis,
the intersection between the junction of the outer shroud with the radially outer end of the structural arm forming the aerodynamic flowpath outer opening and the plane passing through the master cross-section of the structural arm, defines an outer opening radius Rₑ₂ along the radial axis,
wherein the method includes a step of manufacturing the casing during which a calculated trailing edge outer flowpath tangent
$${Γ}_{e 2 , BF}^{′}$$
is defined as
$${Γ}_{e 2 , BF}^{′} = {Γ}_{e Ref , BF} - \vert \frac{{R}_{e 2} - {R}_{eRef}}{{x}_{MC} - {x}_{e , BF}} \vert$$
with
$${Γ}_{e Ref , BF} = \frac{{R}_{eRef} - {R}_{e , BF}}{{x}_{M C} - {x}_{e , BF}}$$
where:
Γ_{eRef, BF} is the trailing edge reference outer flowpath tangent, passing through the second outer inflection point of the trailing edge of the structural arm and through the reference outer opening point, located at the reference outer radius R_{eRef} along the radial axis and at the mean position of the master cross-section along the longitudinal axis,
R_{e, BF} is the radius along the radial axis of the second outer inflection point of the trailing edge of the structural arm,
x_{e, BF} is the position along the longitudinal axis-of the second outer inflection point of the trailing edge of the structural arm,
and during which the trailing edge outer flowpath tangent Γ_{e2, BF}, passing through the second outer inflection point of the trailing edge of the structural arm and through the outer opening point, located at the outer opening radius Rₑ₂ and at the mean position of the master cross-section along the longitudinal axis, is chosen such that 0.95×
$${Γ}_{e 2 , BF}^{′} \leq {Γ}_{e 2} , B F < {Γ}_{eRef , BF} .$$

23. The manufacturing method according to claim 22, wherein a calculated outer opening radius
$${R}_{e 2}^{′}$$
is defined As
$${R}_{e 2}^{′} = \frac{- {b}_{e} + \sqrt{{Δ}_{e}}}{2 {a}_{e}}$$
with
$${Δ}_{e} = {b}_{e}^{2} - 4 {a}_{e} {c}_{e}$$
and
$${b}_{e} = - \frac{M C}{π} {N}_{b}$$
and
$${c}_{e} = - ( \frac{χ {S}_{o}}{π} - \frac{MC}{π} {N}_{b} {R}_{eRef} + {R}_{eRef}^{2} )$$
and Sₒ=MC(R_{eRef}−R_{iRef})N_{b}
where:
MC is the master cross-section of the structural arm,
Nb is the number of structural arms of the casing,
χ is a distribution factor of the obstructed section Sₒ,
aₑ is a predefined coefficient,
the method including a step of manufacturing the casing during which:
R_{eRef} is chosen such that 0.21 m≤R_{eRef}≤0.30 m,
R_{iRef} is chosen such that 0.14 m≤R_{iRef}≤0.23 m,
MC is chosen such that 0.018 m≤MC≤0.035 m,
Nb is chosen such that 8≤Nb≤24,
Sₒ is chosen such that 0.01 m²≤Sₒ≤0.10 m² χ is chosen such that 0≤χ<1,
aₑ is chosen such that aₑ=1.

24. The manufacturing method according to claim 23, including a step of manufacturing the casing during which the outer opening radius Rₑ₂ is chosen such that
$${R}_{eRef} < {R}_{e 2} \leq {R}_{e 2}^{′} .$$

25. The manufacturing method according to claim 23, including a step of manufacturing the casing during which the outer opening radius Rₑ₂ is chosen such that
$${R}_{e 2} = {R}_{e 2}^{′} \times \frac{1}{ε}$$
where:
ε is a resetting factor of the radius Rₑ₂ is chosen such that 1≤ε≤1.04.

26. The manufacturing method according to claim 23, including a step of manufacturing the casing during which the outer opening radius Rₑ₂ is chosen such that
$$0.99 \times {R}_{e 2}^{′} \times \frac{1}{ε} \leq {R}_{e 2} \leq 1.01 \times {R}_{e 2}^{′} \times \frac{1}{ε} .$$

27. The manufacturing method according to claim 22, wherein a calculated inner opening radius
$${R}_{i 2}^{′}$$
is defined as
$${R}_{i 2}^{′} = \frac{- {b}_{i} + \sqrt{{Δ}_{i}}}{2 {a}_{i}}$$
with
$${Δ}_{i} = {b}_{i}^{2} - 4 {a}_{i} {c}_{i}$$
and
$${b}_{i} = - \frac{MC}{π} {N}_{b}$$
and
$${c}_{i} = \frac{( 1 - χ ) {S}_{o}}{π} + \frac{MC}{π} {N}_{b} {R}_{iRef} - {R}_{iRef}^{2}$$
where:
aᵢ is a predefined coefficient,
the method including a step of manufacturing the casing during which:
aᵢ is chosen such that aᵢ=1.

28. The manufacturing method according to claim 27, including a step of manufacturing the casing during which the inner opening radius Rᵢ₂ is chosen such that
$${R}_{i 2}^{′} \leq {R}_{i 2} < {R}_{iRef} .$$

29. The manufacturing method according to claim 27, including a step of manufacturing the casing during which the inner opening radius Rᵢ₂ is chosen such that
$${R}_{i 2} = {R}_{i 2}^{′} \times ε$$
where:
ε is a resetting factor of the radius Rᵢ₂ chosen such that 1≤ε≤1.04.

30. The manufacturing method according to claim 27, including a step of manufacturing the casing during which the inner opening radius Rᵢ₂ is chosen such that
$$0.99 \times {R}_{i 2}^{′} \times ε \leq {R}_{i 2} \leq 1.01 \times {R}_{i 2}^{′} \times ε .$$

31. The manufacturing method according to claim 22, including a step of manufacturing the casing during which a calculated leading edge inner flowpath tangent
$${Γ}_{i 2 , BA}^{′}$$
is defined as
$${Γ}_{i 2 , BA}^{′} = {Γ}_{iRef , BA} - \vert \frac{{R}_{i 2} - {R}_{iRef}}{{x}_{MC} - {x}_{i , BA}} \vert$$
with
$${Γ}_{iRef , BA} = \frac{{R}_{iRef} - {R}_{i , BA}}{{x}_{MC} - {x}_{i , BA}}$$
where:
Γ_{iRef, BA} is the leading edge reference inner flowpath tangent, passing through the first inner inflection point of the leading edge of the structural arm and through the reference inner opening point, located at the reference inner radius R_{iRef} along the radial axis and at the mean position of the master cross-section along the longitudinal axis,
R_{i, BA} is the radius along the radial axis of the first inner inflection point of the leading edge of the structural arm,
x_{i, BA} is the position along the longitudinal axis of the first inner inflection point of the leading edge of the structural arm.

32. The manufacturing method according to claim 31, including a step of manufacturing the casing during which the leading edge inner flowpath tangent Γ_{i2, BA}, passing through the first inner inflection point of the leading edge of the structural arm and through the inner opening point, located at the inner opening radius Rᵢ₂ and at the mean position of the master cross-section along the longitudinal axis, is chosen such that 0.95×
$${Γ}_{i 2 , BA}^{′} \leq {Γ}_{i 2 , BA} < {Γ}_{iRef , BA} .$$

33. The manufacturing method according to claim 22, including a step of manufacturing the casing during which a calculated leading edge outer flowpath tangent
$${Γ}_{e 2 , BA}^{′}$$
is defined as
$${Γ}_{e 2 , BA}^{′} = {Γ}_{eRef , BA} + \vert \frac{{R}_{e 2} - {R}_{eRef}}{{x}_{MC} - {x}_{e , BA}} \vert$$
with
$${Γ}_{eRef , BA} = \frac{{R}_{eRef} - {R}_{e , BA}}{{x}_{MC} - {x}_{e , BA}}$$
where:
Γ_{eRef, BA} is the leading edge reference outer flowpath tangent, passing through the first outer inflection point of the leading edge of the structural arm and through the reference outer opening point, located at the reference outer radius R_{eRef} along the radial axis and at the mean position of the master cross-section along the longitudinal axis,
R_{e, BA} is the radius along the radial axis of the first outer inflection point of the leading edge of the structural arm,
x_{e, BA} is the position along the longitudinal axis of the first outer inflection point of the leading edge of the structural arm.

34. The manufacturing method according to claim 33, including a step of manufacturing the casing during which the leading edge outer flowpath tangent Γ_{e2, BA}, passing through the first outer inflection point of the leading edge of the structural arm and through the outer opening point, located at the outer opening radius Rₑ₂ and at the mean position of the master cross-section along the longitudinal axis, is chosen such that
$${Γ}_{eRef , BA} < {Γ}_{e 2 , BA} \leq 1.05 \times {Γ}_{e 2 , BA}^{′} .$$

35. The manufacturing method according to claim 22, including a step of manufacturing the casing during which a calculated trailing edge inner flowpath tangent
$${Γ}_{i 2 , BF}^{′}$$
is defined as
$${Γ}_{i 2 , BF}^{′} = {Γ}_{iRef , BF} + \vert \frac{{R}_{i 2} - {R}_{iRef}}{{x}_{MC} - {x}_{i , BF}} \vert$$
with
$${Γ}_{iRef , BF} = \frac{{R}_{iRef} - {R}_{i , BF}}{{x}_{MC} - {x}_{i , BF}}$$
where:
Γ_{iRef, BF} is the trailing edge reference inner flowpath tangent, passing through the second inner inflection point of the trailing edge of the structural arm and through the reference inner opening point, located at the reference inner radius R_{iRef} along the radial axis and at the mean position of the master cross-section along the longitudinal axis,
R_{i, BF} is the radius along the radial axis of the second inner inflection point of the trailing edge of the structural arm,
x_{i, BF} is the position along the longitudinal axis of the second inner inflection point of the trailing edge of the structural arm.

36. The manufacturing method according to claim 35, including a step of manufacturing the casing during which the trailing edge inner flowpath tangent Γ_{i2, BF}, passing through the second inner inflection point of the trailing edge of the structural arm and through the inner opening point, located at the inner opening radius Rᵢ₂ and at the mean position of the master cross-section along the longitudinal axis, is chosen such that
$${Γ}_{iRef , BF} < {Γ}_{i 2 , BF} \leq 1.05 \times {Γ}_{i 2 , BF}^{′} .$$

37. The manufacturing method according to claim 22, wherein the aerodynamic flowpath outer opening has, by sectional observation in a plane defined by the tangential axis and the radial axis at the level of the plane passing through the master cross-section of the structural arm, an outer circular ring representing the excess section related to the aerodynamic flowpath outer opening relative to the section obstructed by the structural arm,
the outer circular ring being defined as
$$Δ {S}_{e} = π ( {R}_{e 2}^{2} - {R}_{eRef}^{2} ) - MC ( {R}_{e 2} - {R}_{eRef} ) {N}_{b} = χ {S}_{o}$$
the method including a step of manufacturing the casing during which the parameter ΔSₑ is chosen such that ΔSₑ is strictly greater than 0% and strictly less than 100% of the obstructed section Sₒ.

38. The manufacturing method according to claim 37, including a step of manufacturing the casing during which the parameter ΔSₑ is chosen such that ΔSₑ is comprised between 40% and 60% of the obstructed area Sₒ.

39. The manufacturing method according to claim 22, wherein the aerodynamic flowpath inner opening has, by sectional observation in a plane defined by the tangential axis and the radial axis at the level of the plane passing through the master cross-section of the structural arm, an inner circular ring representing the excess section related to the aerodynamic flowpath inner opening relative to the section obstructed by the structural arm,
the inner circular ring being defined as
$$Δ {S}_{i} = π ( {R}_{iRef}^{2} - {R}_{i 2}^{2} ) - MC ( {R}_{iRef} - {R}_{i 2} ) {N}_{b} = ( 1 - χ ) {S}_{o}$$
the method including a step of manufacturing the casing during which the parameter ΔSᵢ is chosen such that ΔSᵢ is strictly greater than 0% and strictly less than 100% of the obstructed section Sₒ.

40. The manufacturing method according to claim 39, including a step of manufacturing the casing during which the parameter ΔSᵢ is chosen such that ΔSᵢ is comprised between 40% and 60% of the obstructed section Sₒ.
